(19) United States
(12) Patent Application Publication
(10) Pub. No.: US 2004/0230380 A1
(43) Pub. Date: Nov. 18, 2004

(54) Novel proteins with altered immunogenicity

(75) Inventors: Arthur J. Chirino, Camarillo, CA (US); Bassil I. Dahiyat, Altadena, CA (US); John Rudolph Desjarlais, Pasadena, CA (US); Shannon Alicia Marshall, San Francisco, CA (US)

Correspondence Address: Robin M. Silva, Esq., Dorsey & Whitney LLP, Intellectual Property Department, Four Embarcadero Center, Suite 3400, San Francisco, CA, 94111-4187, US

(73) Assignee: Xencor

(21) Appl. No.: 10/754,296

(22) Filed: Jan. 8, 2004

Related U.S. Application Data
(63) Continuation-in-part of application No. 10/339,788, filed on Jan. 8, 2003.
(63) Continuation-in-part of application No. 10/039,170, filed on Jan. 4, 2002.
(60) Provisional application No. 60/432,909, filed on Dec. 11, 2002.

(51) Int. Cl. G06F 19/00

(52) U.S. Cl. 702/19

(57) ABSTRACT

The present invention provides methods for combining computational methods for modulating protein immunogenicity with computational methods for identifying sequences with desired structural and functional properties. More specifically, the methods of the present invention may be used to identify modifications that increase or decrease the immunogenicity of a protein by affecting antigen uptake, MHC binding, T-cell binding, or antibody binding, while retaining or enhancing functional properties.

This application claims the benefit under §§119/120 of the filing date of U.S. Ser. No. 10/339,788, filed Jan. 8, 2003, which claims the benefit of the filing date of U.S. Ser. No. 60/432,909, filed Dec. 11, 2002, and is a Continuation-in-Part of U.S. Ser. No. 10/039,170, filed Jan. 4, 2002, and a U.S. Ser. No. 09/903,378, filed Jul. 10, 2001, which claims the benefit of the filing date of U.S. Ser. No. 60/416,305 filed Oct. 3, 2002, all of which are incorporated by reference in entirety.

### BACKGROUND OF THE INVENTION

1. Field of the Invention

The present invention relates to methods for generating proteins with desired functional and immunological properties. The invention describes methods combining the use of computational immunogenicity filters with computational protein design algorithms. More specifically, the methods of the present invention may be used to identify modifications that increase or decrease the immunogenicity of a protein by affecting antigen uptake, MHC binding, T-cell binding, or antibody binding, while retaining or enhancing functional properties.

2. Description of Related Art

Immunogenicity is a complex series of responses to a substance that is perceived as foreign and may include production of neutralizing and non-neutralizing antibodies, formation of immune complexes, complement activation, mast cell activation, inflammation, hypersensitivity responses, and anaphylaxis. Properly modulating the immunogenicity of proteins may greatly improve the safety and efficacy of protein vaccines and protein therapeutics. Furthermore, methods to predict the immunogenicity of novel engineered proteins will be critical for the development and clinical use of designed protein therapeutics. In the case of protein vaccines, the goal is typically to promote, in a large fraction of patients, a robust T cell or B cell-based immune response to a pathogen, cancer, toxin, or the like. For protein therapeutics, however, unwanted immunogenicity can reduce drug efficacy and lead to dangerous side effects. Immunogenicity has been clinically observed for most protein therapeutics, including drugs with entirely human sequence content.

To elicit an immune response, a protein vaccine or therapeutic must productively interact with several classes of immune cells, including antigen presenting cells (APCs), T cells, and B cells. Each of these classes of cells recognize distinct antigen features: APCs express MHC molecules that recognize MHC agretopes, T cells express T-cell receptors (TCRs) that recognize T-cell epitopes in the context of peptide-MHC complexes, and B cells express MHC molecules and B-cell receptors (BCRs) that recognize B-cell epitopes. Furthermore, uptake by APCs is promoted by binding to any of a number of receptors on the surface of APCs. Finally, particulate protein antigens may be more immunogenic than soluble protein antigens.

Immunogenicity may be dramatically reduced by blocking any of these recognition events. Similarly, immunogenicity may be enhanced by promoting these recognition events. Several factors can contribute to protein immunogenicity, including but not limited to the protein sequence, the route and frequency of administration, and the patient population. Accordingly, modifying these and other factors may serve to modulate protein immunogenicity. A number of examples of methods to increase or decrease immunogenicity have been disclosed.

The presence of additional components in the formulated protein may affect immunogenicity. For example, the addition of any of a number of adjuvants that are known in the art may increase immunogenicity. Similarly, the presence of impurities may promote unwanted immune responses to protein therapeutics (Porter J. Pharm. Sci. 90: 1-11 (2003)).

In general, proteins with non-human sequence content are more likely to elicit an immune response in human patients than fully human proteins. As a result, it is possible to reduce immunogenicity by replacing non-human sequences with human sequences. For example, porcine and bovine insulin elicit antibodies with higher affinity and binding capacity than human insulin does (Porter J. Pharm. Sci. 90: 1-11 (2001)). Similarly, murine antibodies are often immunogenic in human patients. To reduce immune responses to antibody therapeutics, several approaches to minimize or eliminate murine sequence content were developed. Chimeric antibodies comprise mouse variable regions and human constant regions, humanized antibodies are made by grafting murine complementarity-determining regions (CDRs) onto a human framework, and fully human antibodies are produced by phage display or in transgenic mice.

Particulate antigens are more likely to elicit an immune response than soluble protein antigens (Moore and Leppert, J. Clin. Endocrin. Metab. 51: 691-697 (1980), Braun et al. Pharm Res. 14: 1472-1478 (1997) and Schellekens Curr. Med. Res. Opin. 19: 433-434 (2003)). Accordingly, immunogenicity may be modulated by controlling the oligomerization or association state of the protein. For example, some adjuvants are thought to promote immunogenicity by promoting antigen aggregation, thereby prolonging interactions between the antigen and cells of the immune system (Schijns Crit. Rev. Immunol. 21: 75-85 (2001)). A number of examples of increasing protein solubility have been described (see, for example, Arakawa et. al. J. Protein Chem. 12: 525 (1993), Agren et. al. Protein Eng. 12: 173 (1999), Tan et. al. Immunotechnology 4: 107 (1998), and Clark et. al. FEBS. Lett. 471: 182 (2000)); although the goals of these studies did not include reducing immunogenicity or limiting uptake by antigen presenting cells.

Methods to modify APC internalization by adding or removing motifs that interact with receptors on the surface of APCs have been described. In one embodiment, the immunogenicity of a peptide is enhanced by conjugating it to an antibody that promotes antigen uptake by binding to an APC cell surface receptor (EP 0759944 B1).

Methods to identify and add or remove class I or class II MHC agretopes have been described. For example, vaccines can be made that are more effective at inducing an immune response by inserting agretopes with increased affinity for MHC class I or class 11 molecules (see for example, WO 9833523; Sarobe, P., et al. J. Clin. Invest., 102:1239-1248 (1998); Thimme, R., et al. J. Virology, 75:3984-3987 (2001); Roberts, C., et al., Aids Research and Human Retroviruses, 12: 593-610 (1996); Kobayashi, H., et al., Cancer Res., 60: 5228-5236 (2000); Keogh, E., et al., J. Immunology, 167: 787-796 (2001); Want, R-F., Trends in Immunology, 22: 269-276 (2001); Mucha et al. BMC Immunol. 3: 1-12 (2002)). Removal of MHC agretopes for the purpose of decreasing protein immunogenicity has also been disclosed (for example WO 98/52976, WO 02/079232, WO 00/34317, and WO 02/069232). Addition or removal of MHC agretopes is a tractable approach for immunogenicity modulation because the factors affecting binding are reasonably well defined, the diversity of binding sites is limited, and MHC molecules and their binding specificities are static throughout an individual's lifetime. A key limitation to current MHC epitope removal approaches is that many of the substitutions that most effectively reduce MHC binding are likely to also disrupt the desired structure and function of the protein.

Methods to identify and add or remove T-cell epitopes have been described. For example, vaccines are made that are more effective at inducing an immune response by inserting at least one T cell epitope (de Lalla, C., et al., J. Immunology, 163:1725-1729 (1999); Kim and DeMars, Curr. Op Immunology, 13:429-436 (2001); and Berzofsky, J. A., et al., EP 0 273 716B1).

Methods to add or remove one or more antibody (BCR) epitopes from a protein have been disclosed. For example, vaccines have been made more effective at inducing an immune response by inserting a sequence encoding at least one conformational epitope that interacts with membrane bound antibodies on naive B cells (see Criag, L., et al., (1998) J. Mol. Biol., 281:183-201; Buttinelli, G., et al., (2001) Virology, 281:265-271; Saphire, E. O., et al., (2001) Science, 293:1155; Mascola and Nabel, (2001) Curr. Op. Immunology, 13:489-495; all references hereby incorporated by reference in their entirety). Antibody epitopes may be modified to minimize antibody binding (Barrow et al. Blood 95: 564-568 (2000), Spiegel and Stoddard Br. J. Haematol. 119: 310-322 (2002), Collen D. et. al. Circulation 94: 197-206 (1996) and Laroche et. al. Blood 96: 1425-1432 (2000)). Antibody epitopes often comprise charged or hydrophobic residues on the protein surface, and replacing such residues with small, neutral residues may reduce antigenicity. However, due to the tremendous diversity of the antibody repertoire, repeated administration of a protein therapeutic with modified antibody epitopes may result in eliciting a new antibody response against another set of epitopes rather than a sustained reduction in immunogenicity.

Methods to sterically block antibody binding by attaching one or more molecules of polyethylene glycol (“PEG”) to the protein have been disclosed (see for example Harris et. al. Clin. Pharmacokinet. 40: 539-551 (2001), Savoca et al. Biochim. Biophys. Acta 578: 47053 (1979) and Hershfield et al. Proc. Nat. Acad. Sci. USA 88: 7185-7189 (1991)). PEGylation may also modulate immunogenicity by allowing reduced dosing frequency and by improving solubility. However, PEGylation may also sterically block binding to desired receptors, thereby reducing therapeutic efficacy. Furthermore, PEGylated therapeutics may still retain appreciable immunogenicity.

It is possible to combine approaches for immunogenicity modulation. For example, more immunogenic vaccines have been made by inserting any combination of B cell epitopes, MHC class I binding motifs, MHC class II binding motifs, and T cell epitopes (see for example WO 01/41788 and U.S. Pat. No. 6,037,135).

As described above, a key limitation of current strategies for modulating protein immunogenicity is that many of the suggested modifications may be incompatible with the desired function of the protein.

A number of methods have been described for identifying protein sequences that are compatible with a target structure and function. These include, but are not limited to, sequence alignment methods, structure alignment methods, sequence profiling methods, and energy calculation methods.

In a preferred embodiment, the computational method used to identify protein sequences with desired functional properties is Protein Design Automation® (PDA®) technology, as is described in U.S. Pat. Nos. 6,188,965; 6,269,312; 6,403,312; WO98/47089 and U.S. Ser. Nos. 09/058,459, 09/714,357, 09/812,034, 09/827,960, 09/837,886, 09/877,695,10/071,85909/419,351, 09/782,004 and 09/927,790, 60/347,772, 10/101,499, and 10/218,102; and PCT/US01/218,102 and U.S. Ser. No.10/218,102, U.S. Ser. No.60/345,805; U.S. Ser. No. 60/373,453 and U.S. Ser. No.60/374,035, all of which are expressly incorporated herein by reference. Briefly, PDA® technology may be described as follows. A protein structure (which may be determined experimentally, generated by homology modeling or produced de novo) is used as the starting point. The positions that are allowed to vary are then identified, which may be the entire sequence or subset(s) thereof. The amino acids that will be considered at each variable position are selected. Optionally, each amino acid residue may be represented by a discrete set of allowed conformations, called rotamers. Interaction energies are calculated using a scoring function between (1) each allowed residue or rotamer at each variable position and the backbone, (2) each allowed residue or rotamer at each variable position and each non-variable residue (if any), and (3) each allowed residue or rotamer at each variable position and each allowed residue or rotamer at each other variable position. Combinatorial search algorithms, typically DEE and Monte Carlo, are used to identify the optimum amino acid sequence and additional low energy sequences. The resulting sequences may be generated experimentally or subjected to further computational analysis.

A key limitation of current computational protein design algorithms is that the immunological properties of the generated sequences are not explicitly considered. As immunogenicity may significantly affect the safety and efficacy of protein therapeutics and protein vaccines, methods to evaluate the immunogenicity of designed proteins intended for use as drugs or vaccines would be useful.

In summary, there is a need for additional immunogenicity reduction methods for non-human proteins, and even proteins with fully human sequences. A need still remains for methods to identify protein sequences with desired physical, chemical, biological, and immunological properties. The present invention provides methods for combining computational methods for modulating protein immunogenicity with computational methods for identifying sequences with desired structural and functional properties.

### SUMMARY OF THE INVENTION

In accordance with the objects outlined above, the present invention provides methods for generating proteins exhibiting desired functional and immunological properties, comprising applying, to at least one protein sequence, at least one computational method that analyzes structural or functional properties and at least one computational method that analyzes immunogenicity.

In one aspect, the present invention provides methods for generating proteins with increased immunogenicity. Such proteins may find use as vaccines.

In an additional aspect, the present invention provides methods for generating proteins with reduced immunogenicity. Such proteins may constitute safer or more effective protein therapeutics.

In an additional aspect, the present invention provides methods for generating novel engineered proteins with minimal immunogenicity. Such proteins may constitute safe and effective novel protein therapeutics.

In a further aspect, the invention provides a method of generating recombinant nucleic acids encoding proteins with desired immunological and functional properties, expression vectors, and host cells.

In an additional aspect, the invention provides methods of producing proteins with desired immunological and functional properties comprising culturing the host cells of the invention under conditions suitable for expression of the protein.

In a further aspect, the invention provides methods for generating pharmaceutical compositions comprising a protein with desired immunological and functional properties or a nucleic acid encoding a protein with desired immunological and functional properties and a pharmaceutical carrier.

In a further aspect, the invention provides methods for preventing or treating disorders comprising administering a protein with desired immunological and functional properties or a nucleic acid encoding a protein with desired immunological and functional properties of the invention to a patient.

### DETAILED DESCRIPTION OF PREFERRED EMBODIMENTS

By “9-mer peptide frame” and grammatical equivalents herein is meant a linear sequence of nine amino acids that is located in a protein of interest. 9-mer frames may be analyzed for their propensity to bind one or more class II MHC alleles. By “allele” and grammatical equivalents herein is meant an alternative form of a gene. Specifically, in the context of class II MHC molecules, alleles comprise all naturally occurring sequence variants of DRA, DRB1, DRB3/4/5, DQA1, DQB1, DPA1, and DPB1 molecules. By “anchor residue” and grammatical equivalents herein is meant a position in an MHC agretope that is especially important for conferring MHC binding affinity or determining whether a given sequence will bind a given MHC allele. For example, the P1 position is an anchor residue for DR alleles, as the presence of a hydrophobic residue at P1 is required for DR binding. By “antibody epitope” or “B-cell receptor epitope” and grammatical equivalents herein is meant one or more residues in a protein that are capable of being recognized by one or more antibodies. As is known in the art, antibody epitopes may comprise “conformational epitopes”, or sets of residues that are located nearby in the tertiary structure of the protein but are not adjacent in the primary sequence. By “antigenicity” and grammatical equivalents herein is meant the ability of a molecule, for example a protein, to be recognized by antibodies. By “computational immunogenicity filter” herein is meant any of a number of computational algorithms that is capable of differentiating protein sequences on the basis of immunogenicity. Computational immunogenicity filters include scoring functions that are derived from data on binding of peptides to MHC and TCR molecules as well as data on protein-antibody interactions. In a preferred embodiment, the immunogenicity filter comprises matrix method calculations for the identification of MHC agretopes. By “computational protein design algorithm” and grammatical equivalents herein is meant any computational method that may be used to identify variant protein sequences that are capable of folding to a desired protein structure or possessing desired functional properties. In a preferred embodiment the computational protein design algorithm is Protein Design Automation® technology. By “conservative modification” and grammatical equivalents herein is meant a modification in which the parent protein residue and the variant protein residue are substantially similar with respect to one or more properties such as hydrophobicity, charge, size, and shape. By “hit” and grammatical equivalents herein is meant, in the context of the matrix method, that a given peptide is predicted to bind to a given class II MHC allele. In a preferred embodiment, a hit is defined to be a peptide with binding affinity among the top 5%, or 3%, or 1% of binding scores of random peptide sequences. In an alternate embodiment, a hit is defined to be a peptide with a binding affinity that exceeds some threshold, for instance a peptide that is predicted to bind an MHC allele with at least 100 μM or 10 μM or 1 μM affinity. By “immunogenicity” and grammatical equivalents herein is meant the ability of a protein to elicit an immune response, including but not limited to production of neutralizing and non-neutralizing antibodies, formation of immune complexes, complement activation, mast cell activation, inflammation, and anaphylaxis. Immunogenicity is species-specific. In a preferred embodiment, immunogenicity refers to immunogenicity in humans. In an alternate embodiment, immunogenicity refers to immunogenicity in rodents, (rats, mice, hamster, guinea pigs, etc.), primates, farm animals (including sheep, goats, pigs, cows, horses, etc.), and domestic animals, (including cats, dogs, rabbits, etc). By “immunogenic sequences” herein is meant sequences that promote immunogenicity, including but not limited to antigen processing cleavage sites, class I MHC agretopes, class II MHC agretopes, T-cell epitopes, and B-cell epitopes. By “enhanced immunogenicity” and grammatical equivalents herein is meant an increased ability to activate the immune system, when compared to a parent protein. For example, a variant protein can be said to have “enhanced immunogenicity” if it elicits neutralizing or non-neutralizing antibodies in higher titer or in more patients than the parent protein. In a preferred embodiment, the probability of raising neutralizing antibodies is increased by at least 5%, with at least 2-fold or 5-fold increases being especially preferred. So, if a wild type produces an immune response in 10% of patients, a variant with reduced immunogenicity would produce an immune response in at least 10.5% of patients, with more than 20% or more than 50% being especially preferred. A variant protein also can be said to have “increased immunogenicity” if it shows increased binding to one or more MHC alleles or if it induces T-cell activation in a increased fraction of patients relative to the parent protein. In a preferred embodiment, the probability of T-cell activation is increased by at least 5%, with at least 2-fold or 5-fold increases being especially preferred. By “reduced immunogenicity” and grammatical equivalents herein is meant a decreased ability to activate the immune system, when compared to a parent protein. For example, a variant protein can be said to have “reduced immunogenicity” if it elicits neutralizing or non-neutralizing antibodies in lower titer or in fewer patients than the parent protein. In a preferred embodiment, the probability of raising neutralizing antibodies is decreased by at least 5%, with at least 50% or 90% decreases being especially preferred. So, if a wild type produces an immune response in 10% of patients, a variant with reduced immunogenicity would produce an immune response in not more than 9.5% of patients, with less than 5% or less than 1% being especially preferred. A variant protein also can be said to have “reduced immunogenicity” if it shows decreased binding to one or more MHC alleles or if it induces T-cell activation in a decreased fraction of patients relative to the parent protein. In a preferred embodiment, the probability of T-cell activation is decreased by at least 5%, with at least 50% or 90% decreases being especially preferred. By “matrix method” and grammatical equivalents thereof herein is meant a method for calculating peptide—MHC affinity in which a matrix is used that contains a score for one or more possible residues at one or more positions in the peptide, interacting with a given MHC allele. The binding score for a given peptide—MHC interaction is obtained by summing the matrix values for the amino acids observed at each position in the peptide. By “MHC-binding agretopes” and grammatical equivalents herein is meant peptides that are capable of binding to one or more class I or class II MHC alleles with appropriate affinity to enable the formation of MHC—peptide—T-cell receptor complexes and subsequent T-cell activation. Class II MHC-binding epitopes are linear peptide sequences that comprise at least approximately 9 residues. By “parent protein” as used herein is meant a protein that is subsequently modified to generate a variant protein. Said parent protein may be a wild-type or naturally occurring protein, a variant or engineered version of a naturally occurring protein, or a de novo engineered protein. “Parent protein” may refer to the protein itself, compositions that comprise the parent protein, or any amino acid sequence that encodes it. By “patient” herein is meant both humans and other animals, particularly mammals, and organisms. Thus the methods are applicable to both human therapy and veterinary applications. In the preferred embodiment the patient is a mammal, and in the most preferred embodiment the patient is human. By “protein” herein is meant at least two covalently attached amino acids, which includes proteins, polypeptides, oligopeptides and peptides. The protein may be made up of naturally occurring amino acids and peptide bonds, or synthetic peptidomimetic structures, i.e., “analogs” such as peptoids [see Simon et al., Proc. Natl. Acad. Sci. U.S.A. 89(20:9367-71 (1992)], generally depending on the method of synthesis. For example, homo-phenylalanine, citrulline, and noreleucine are considered amino acids for the purposes of the invention. “Amino acid” also includes amino acid residues such as proline and hydroxyproline. Both D- and L- amino acids may be utilized. By “protein properties” herein is meant, biological, chemical, and physical properties including, but not limited to, enzymatic activity or specificity (including substrate specificity, kinetic association and dissociation rates, reaction mechanism, and pH profile), stability (including thermal stability, stability as a function of pH or solution conditions, resistance or susceptibility to ubiquitination or proteolytic degradation), solubility (including susceptibility to aggregation and crystallization), binding affinity or specificity (to one or more molecules including proteins, nucleic acids, polysaccharides, lipids, and small molecules), oligomerization state, dynamic properties (including conformational changes, allostery, correlated motions, flexibility, rigidity, folding rate), subcellular localization, ability to be secreted, ability to be displayed on the surface of a cell, susceptibility to co- or posttranslational modification (including N- or C-linked glycosylation, lipidation, and phosphorylation), ammenability to synthetic modification (including PEGylation, attachment to other molecules or surfaces), and ability to induce altered phenotype or changed physiology (including cytotoxic activity, immunogenicity, toxicity, ability to signal, ability to stimulate or inhibit cell proliferation, ability to induce apoptosis, and ability to treat disease). By “T-cell epitope” and grammatical equivalents herein is meant a residue or set of residues that are capable of being recognized by one or more T-cell receptors. As is known in the art, T cells recognize linear peptides that are bound to MHC molecules. By “treatment” herein is meant to include therapeutic treatment, as well as prophylactic, or suppressive measures for the disease or disorder. Thus, for example, successful administration of a variant protein prior to onset of the disease may result in treatment of the disease. As another example, successful administration of a variant protein after clinical manifestation of the disease to combat the symptoms of the disease comprises “treatment” of the disease. “Treatment” also encompasses administration of a variant protein after the appearance of the disease in order to eradicate the disease. Successful administration of an agent after onset and after clinical symptoms have developed, with possible abatement of clinical symptoms and perhaps amelioration of the disease, further comprises “treatment” of the disease. Those “in need of treatment” include mammals already having the disease or disorder, as well as those prone to having the disease or disorder, including those in which the disease or disorder is to be prevented. By “variant nucleic acids” and grammatical equivalents herein is meant nucleic acids that encode variant proteins of the invention. Due to the degeneracy of the genetic code, an extremely large number of nucleic acids may be made, all of which encode the variant proteins of the present invention, by simply modifying the sequence of one or more codons in a way which does not change the amino acid sequence of the variant protein. By “variant proteins” and grammatical equivalents thereof herein is meant non-naturally occurring proteins which differ from a wild type or parent protein by at least 1 amino acid insertion, deletion, or substitution. Variant proteins are characterized by the predetermined nature of the variation, a feature that sets them apart from naturally occurring allelic or interspecies variation. Variant proteins typically either exhibit biological activity that is comparable to the parent protein or have been specifically engineered to have alternate biological properties. The variant proteins may contain insertions, deletions, and/or substitutions at the N-terminus, C-terminus, or internally. In a preferred embodiment, variant proteins have at least 1 residue that differs from the parent protein sequence, with at least 2, 3, 4, or 5 different residues being more preferred. Variant proteins may contain further modifications, for instance mutations that alter stability or solubility or which enable or prevent posttranslational modifications such as PEGylation or glycosylation. Variant proteins may be subjected to co- or post-translational modifications, including but not limited to synthetic derivatization of one or more side chains or termini, glycosylation, PEGylation, circular permutation, cyclization, fusion to proteins or protein domains, and addition of peptide tags or labels. In a preferred embodiment, variant proteins also have substantially similar function (excepting immunogenicity) to the biological function of the parent; “substantially similar” in this case meaning at least 50-75-80-90-95% of the biological function. By “wild type or wt” and grammatical equivalents thereof herein is meant an amino acid sequence or a nucleotide sequence that is found in nature and includes allelic variations; that is, an amino acid sequence or a nucleotide sequence that has not been intentionally modified.

Proteins with desired immunological and functional properties can serve as valuable therapeutics or vaccines. However, efforts to modulate immunogenicity while conserving function have met with only limited success. Mutations that confer desired immunological properties and mutations that confer desired functional properties are both typically rare, and so mutations that confer both sets of properties are even less frequent. As a result, proteins that are engineered for reduced or increased immunogenicity often lack desired functional properties, and proteins that are designed for improved function may possess unwanted immunogenicity. It is possible to screen variants with altered immunogencity for function, or to screen functional variants for desired immunological properties. However, the experimental cell-based or in vivo methods used to assay the function and immunogenicity of protein therapeutics and vaccines are often extremely low throughput, so it may not be practical to screen sufficient variants to identify one or more with desired functional and immunological properties.

The present invention is directed to computational methods, comprising computational protein design algorithms and computational immunogenicity filters, that may analyze up to 10⁸⁰ or more protein sequences to select smaller libraries of protein sequences. For example, if a protein with reduced immunogenicity is desired, computational methods may be used to identify and replace residues that promote immunogenicity with alternate residues that maintain the native structure and function of the protein; thereby generating a functional, less immunogenic variant. If a protein with increased immunogenicity is desired, computational methods may be used to introduce one or more epitopes or agretopes while maintaining desired functional properties. The resulting protein libraries are greatly enriched for variants that possess desired functional and immunological properties. Even if only a small number of variants are assayed experimentally, a high quality library should contain at least one hit.

The present invention comprises three basic approaches to generate proteins with desired functional and immunological properties: (1) use a computational protein design algorithm to identify a set of proteins that are predicted to possess desired functional properties, and then use a computational immunogenicity filter to identify the subset of proteins that also possess desired immunological properties; (2) use a computational protein design algorithm to identify a set of proteins that are predicted to possess desired immunological properties, and then use a computational immunogenicity filter to identify the subset of proteins that also possess desired functional properties; or (3) use a computational algorithm comprising both protein design and immunogenicity filter algorithms that generates proteins with desired functional and immunological properties.

Examples of Suitable Parent Proteins

The methods described herein may be applied to any protein. In a preferred embodiment, the three-dimensional structure of the parent protein is known or may be generated using experimental methods, homology modeling, or de novo fold prediction methods. However, in some embodiments, it is possible to generate variants without a three-dimensional structure of the parent protein.

Suitable proteins include, but are not limited to, industrial, pharmaceutical, and agricultural proteins, including ligands, cell surface receptors, antigens, antibodies, cytokines, hormones, transcription factors, signaling modules, cytoskeletal proteins and enzymes.

In a preferred embodiment, the parent protein is a protein therapeutic that has been demonstrated to be immunogenic in humans, including but not limited to alpha-galactosidase, adenosine deamidase, arginase, asparaginase, bone morphogenic protein-7, ciliary neurotrophic factor, DNase, erythropoietin, factor IX, factor VIII, follicle stimulating hormone, glucocerebrocidase, gonadotrophin-releasing hormone, granulocyte-colony stimulating factor, granulocyte-macrophage-colony stimulating factor, growth hormone, growth hormone releasing hormone, human chorionic gonadotrophin, insulin, interferon alpha, interferon beta, interferon gamma, interleukin-2, interleukin-3, interleukin-11, salmon calcitonin, staphylokinase, streptokinase, tissue plasminogen activator, and thrombopoietin. The parent protein may also comprise an extracellular domain of a receptor, including but not limited to CD4, interleukin-1 receptor, and tumor necrosis factor receptors. In addition, the parent protein may be any antibody, including a murine, chimeric, humanized, camelized, lamalized, single chain, or fully human antibody.

In another preferred embodiment, the parent protein is a toxin that is used for therapeutic purposes. Preferred therapeutic toxin parent proteins include but are not limited to botulinum toxin, ricin, and tetanus toxin.

In another preferred embodiment, the parent protein is a designed or engineered protein that is being developed or used as a therapeutic. Such parent proteins include, but are not limited to, fusion proteins, proteins comprising one or more point mutations, chimeric proteins, truncated proteins, and the like.

In an additional preferred embodiment, the parent protein is a protein associated with an allergen, viral pathogen, bacterial pathogen, other infectious agent, or cancer. Variants of such parent proteins may serve as vaccines that are effective against allergens, bacterial pathogens, viral pathogens and tumors (see for example, WO/41788; U.S. Pat. Nos. 6,322,789; 6,329,505; WO 01/41799; WO 01/42267; WO 01/42270; and WO 01/45728).

Preferred allergen-derived parent proteins include but are not limited to proteins in chemical allergens, food allergens, pollen allergens, fungal allergens, pet dander, mites, etc (see Huby, R. D. et al., Toxicological Science, 55:235-246 (2000)).

Preferred viral pathogen-derived parent proteins include but are not limited to proteins expressed by Hepatitis A, Hepatitis B, Hepatitis C, poliovirus, HIV, herpes simplex I and II, small pox, human papillomavirus, cytomegalovirus, hantavirus, rabies, Ebola virus, yellow fever virus, rotavirus, rubella, measles virus, mumps virus, Varicella (i.e., chicken pox or shingles), influenza, encephalitis, Lassa Fever virus, etc.

Preferred bacterial pathogen-derived parent proteins include but are not limited to proteins expressed by the causative agent of Lyme disease, diphtheria, anthrax, botulism, pertussis, whooping cough, tetanus, cholera, typhoid, typhus, plague, Hansen's disease, tuberculosis (including multidrug resistant forms), staphylococcal infections, streptococcal infections, Listeria, meningococcal meningitis, pneumococcal infections, legionnaires' disease, ulcers, conjunctivitis, etc.

Additional parent proteins derived from infectious agents include but are not limited to proteins expressed by the causative agent of dengue fever, malaria, African Sleeping Sickness, dysentery, Rocky Mountain Spotted Fever, Schistosomiasis, Diarrhea, West Nile Fever, Leishmaniasis, Giardiasis, etc.

Preferred cancer-derived parent proteins include but are not limited to proteins expressed by solid tumors such as skin, breast, brain, cervical carcinomas, testicular carcinomas, etc., such as melanoma antigen genes (MAGE; see WO 01/42267); carcinoembryonic antigen (CEA; see WO 01/42270), prostate cancer antigens (see WO 01/45728 and U.S. Pat. No. 6,329,505), such as prostate specific antigen (PSA), prostate specific membrane antigen (PSM), prostatic acid phosphatase (PAP), and human kallikrein2 (hK2 or HuK2), and breast cancer antigens (i.e., her2/neu; see AU 2087401). Additional cancer-derived proteins include proteins that are expressed in one or more of the following types of cancer: Cardiac: sarcoma (angiosarcoma, fibrosarcoma, rhabdomyosarcoma, liposarcoma), myxoma, rhabdomyoma, fibroma, lipoma and teratoma; Lung: bronchogenic carcinoma (squamous cell, undifferentiated small cell, undifferentiated large cell, adenocarcinoma), alveolar (bronchiolar) carcinoma, bronchial adenoma, sarcoma, lymphoma, chondromatous hamartoma, mesothelioma; Gastrointestinal: esophagus (squamous cell carcinoma, adenocarcinoma, leiomyosarcoma, lymphoma), stomach (carcinoma, lymphoma, leiomyosarcoma), pancreas (ductal adenocarcinoma, insulinoma, glucagonoma, gastrinoma, carcinoid tumors, vipoma), small bowel (adenocarcinoma, lymphoma, carcinoid tumors, Karposi's sarcoma, leiomyoma, hemangioma, lipoma, neurofibroma, fibroma), large bowel (adenocarcinoma, tubular adenoma, villous adenoma, hamartoma, leiomyoma); Genitourinary tract: kidney (adenocarcinoma, Wilm's tumor [nephroblastoma], lymphoma, leukemia), bladder and urethra (squamous cell carcinoma, transitional cell carcinoma, adenocarcinoma), prostate (adenocarcinoma, sarcoma), testis (seminoma, teratoma, embryonal carcinoma, teratocarcinoma, choriocarcinoma, sarcoma, interstitial cell carcinoma, fibroma, fibroadenoma, adenomatoid tumors, lipoma); Liver: hepatoma (hepatocellular carcinoma), cholangiocarcinoma, hepatoblastom, angiosarcoma, hepatocellular adenoma, hemangioma; Bone: osteogenic sarcoma (osteosarcoma), fibrosarcoma, malignant fibrous histiocytoma, chondrosarcoma, Ewing's sarcoma, malignant lymphoma (reticulum cell sarcoma), multiple myeloma, malignant giant cell tumor chordoma, osteochronfroma (osteocartilaginous exostoses), benign chondroma, chondroblastoma, chondromyxofibroma, osteoid osteoma and giant cell tumors; Nervous system: skull (osteoma, hemangioma, granuloma, xanthoma, osteitis deformans), meninges (meningioma, meningiosarcoma, gliomatosis), brain (astrocytoma, medulloblastoma, glioma, ependymoma, germinoma [pinealoma], glioblastoma multiform, oligodendroglioma, schwannoma, retinoblastoma, congenital tumors), spinal cord neurofibroma, meningioma, glioma, sarcoma); Gynecological: uterus (endometrial carcinoma), cervix (cervical carcinoma, pre-tumor cervical dysplasia), ovaries (ovarian carcinoma [serous cystadenocarcinoma, mucinous cystadenocarcinoma, unclassified carcinoma], granulosa-thecal cell tumors, Sertoli-Leydig cell tumors, dysgerminoma, malignant teratoma), vulva (squamous cell carcinoma, intraepithelial carcinoma, adenocarcinoma, fibrosarcoma, melanoma), vagina (clear cell carcinoma, squamous cell carcinoma, botryoid sarcoma [embryonal rhabdomyosarcoma], fallopian tubes (carcinoma); Hematologic: blood (myeloid leukemia [acute and chronic], acute lymphoblastic leukemia, chronic lymphocytic leukemia, myeloproliferative diseases, multiple myeloma, myelodysplastic syndrome), Hodgkin's disease, non-Hodgkin's lymphoma [malignant lymphoma]; Skin: malignant melanoma, basal cell carcinoma, squamous cell carcinoma, Karposi's sarcoma, moles dysplastic nevi, lipoma, angioma, dermatofibroma, keloids, psoriasis; and Adrenal glands: neuroblastoma.

Identification of Immunogenic Sequences in the Parent Protein

In a preferred embodiment, after selection of a parent protein, the parent protein is analyzed to identify one or more immunogenic sequences. These sequences may be targeted for modification in order to confer reduced immunogenicity. Similarly, if enhancing immunogenicity is the goal, analysis of the immunogenic sequences in the parent protein may be used to suggest which classes of immunogenic sequences should be incorporated to increase immunogenicity. Finally, novel sequences including but not limited to those discovered using computational protein design methods may be analyzed for their potential to elicit an immune response using the methods described below.

Identification of Binding Sites for APC Receptors

Receptor mediated endocytosis delivers protein antigens to APCs far more effectively than pinocytosis does, thereby promoting immunogenicity. APCs express a wide variety of receptors, including receptors that bind antibodies, many cytokines and chemokines, and specific glycoforms. Protein antigen interaction with APC cell surface receptors, such as the mannose receptor (Tan M C et al. Adv Exp Med Biol, 417: 171-174 (1997)), increases the efficiency of protein antigen uptake.

In a preferred embodiment, the parent protein is analyzed to determine whether it could act as a ligand for any of the receptors that are present on the surface of APCs. For example, binding assays may be conducted using the parent protein and one or more types of APCs. Furthermore, a number of proteins are already known to bind to one or more receptors on the surface of one or more types of APCs. Receptors that are present on APCs include, but are not limited to, Toll-like receptors (for example receptors for lipopolysaccharide, bacterial proteoglycans, unmethylated CpG motifs, and double stranded RNA), cytokine receptors (for example CD40, Fas, OX40L, gp130, LIFR, and receptors for interferon alpha, interferon-beta, interleukin-1, interleukin-3 interleukin-4, interleukin-10, interleukin-12, tumor necrosis factor alpha), and Fc receptors (for example Fc gamma RI, Fc gamma RIII).

Identification of Residues that Promote Aggregation

Protein aggregation is often driven by the formation of intermolecular disulfide bonds or intermolecular hydrophobic interactions. Accordingly, free cysteines (that is, cysteines that are not participating in disulfide bonds) and solvent exposed hydrophobic residues often mediate aggregation.

In a preferred embodiment, biophysical characterization is performed to determine whether the parent protein is susceptible to aggregation. Methods for assaying for aggregation include, but are not limited to, size exclusion chromatography, dynamic light scattering, analytical ultracentrifugation, UV scattering, and decrease of protein amount or activity over time.

In an alternate preferred embodiment, the parent protein is analyzed to identify any free cysteine residues. This may be done, for example, by inspecting the three-dimensional structure or by performing a sequence alignment and analyzing conservation patterns.

In another preferred embodiment, the parent protein is analyzed to identify any exposed hydrophobic residues. Hydrophobic residues include valine, leucine, isoleucine, methionine, phenylalanine, tyrosine, and tryptophan, and exposed hydrophobic residues are those hydrophobic residues whose side chains are significantly exposed to solvent. In a preferred embodiment, at least 30 Å² of solvent exposed area is present, with greater than 50 Å² or 75 Å² being especially preferred. In an alternate embodiment, at least 50% of the surface area of the side chain is exposed to solvent, with greater than 75% or 90% being preferred.

The isoelectric point or pl (that is, the pH at which the protein has a net charge of zero) of the protein may also affect solubility. As is known in the art, protein solubility is typically lowest when the pH is equal to the pl. Furthermore, proteins with net positive charge may interact with proteoglycans present at the injection site, which may potentially promote aggregation. Accordingly, in a preferred embodiment, the net charge of the parent protein is calculated at physiological pH.

Identification of Class I Antigen Processing Sites

Prior to binding class I MHC molecules, a protein antigen is “processed”, meaning that it is subjected to limited proteolytic cleavage in order to produce peptide fragments. The proteosome performs antigen processing for the class I pathway. Potential proteosomal cleavage sites may be identified by using any of a number of prediction algorithms (see for example Kutter, C., et al., J. Mol. Biol., 298:417-429 (2000) and Nussbaum, A. K., et al., Immunogenetics, 53:87-94 (2001)).

Identification of Class II Antigen Processing Sites

Antigen processing also takes place prior to binding class II MHC molecules. A number of proteolytic enzymes participate in antigen processing for the class II pathway, including but not limited to cathepsins B, D, E, L and asparaginyl endopeptidase. Potential proteolytic cleavage sites may be identified, for example, as described by Schneider, S. C., et al., J. Immunol., 165:20-23 (2000); and by Medd and Chain, Cell Dev. Biol., 11:203-210 (2000).

Identification of Class I MHC-Binding Agretopes

Class I MHC molecules primarily bind fragments of intracellular proteins that are derived from infecting viruses, intracellular parasites, or internal proteins of the cell; proteins that are overexpressed in cancer cells are of special interest. The resulting peptide-MHC complexes are transported to the surface of the APC, where they may interact with T cells via TCRs. This is the first step in the activation of a cellular program that may lead to cytolysis of the APC, secretion of lymphokines by the T cell, or signaling to natural killer cells. The interaction with the TCR is dependent on both the peptide and the MHC molecule. MHC class I molecules show preferential restriction to CD8+ cells. (Fundamental Immunology, 4th edition, W. E. Paul, ed., Lippincott-Raven Publishers, 1999, Chapter 8, pp 263-285).

The factors that determine the affinity of peptide-class I MHC interactions have been characterized using biochemical and structural methods, including sequencing of peptides and natural peptide libraries extracted from MHC proteins. Class I MHC ligands are mostly octa-or nonapeptides; they bind a groove in the class I MHC structure framed by two a helices and a β pleated sheet. A subset of residues in the peptide, called anchor residues, are recognized by specific pockets in the binding groove; these interactions confer some sequence selectivity. Class I MHC molecules also interact with atoms in the peptide backbone. The orientation of the peptides is determined by conserved side chains of the MHC I protein that interact with the N- and C-terminal residues in the peptide.

Any of a number of methods may be used to identify potential class I MHC agretopes, including but not limited to the computational and experimental methods described below.

Rules for identifying MHC I binding sites have been described in Altuvia, Y., et al (1997) Human Immunology, 58:1-11; Meister, G E., et al (1995) Vaccine: 6:581-591; Parker, K. C., et al., (1994) J. Immunology, 152:163; Gulukota, K., et al., (1997) J. Mol. Biol., 267:1258-1267; Buus, S., (1999) Current Opinion Immunology, 11:209-213; hereby incorporated by reference in their entirety). Databases of MCH binding peptide, such as SYPEITHI and MHCPEP may also be used to identify potential MHC I binding sites (Rammensee, H-G., et al., (1999) Immunogenetics, 50:213-219; Brusic, V., et al., (1998) Nucleic Acids Research, 26:368-371). Other methods for identifying MHC binding motifs include allele-specific polynomial algorithms described by Fikes, J., et al., WO 01/41788, neural net (Gulukota, K, supra), polynomial (Gulukota, K., supra) and rank ordering algorithms (Parker, K. C., supra).

Identification of Class II MHC-Binding Agretopes

Class II MHC molecules, which are related to class I MHC molecules, primarily present extracellular antigens. Relatively stable peptide-MHC complexes may be recognized by TCRs; this recognition event is required for the initiation of most antibody-based (humoral) immune responses. MHC class II molecules show preferential restriction to CD4+ cells (Fundamental Immunology, 4th edition, W. E. Paul, ed., Lippincott-Raven Publishers, 1999, Chapter 8, pp 263-285).

The factors that determine the affinity of peptide-class II MHC interactions have been characterized using biochemical and structural methods. Peptides bind in an extended conformation bind along a groove in the class II MHC molecule. While peptides that bind class II MHC molecules are typically approximately 12-25 residues long, a nine-residue region is responsible for most of the binding affinity and specificity. The peptide binding groove can be subdivided into “pockets”, commonly named P1 through P9, where each pocket is comprises the set of MHC residues that interacts with a specific residue in the peptide. Between two and four of these positions typically act as anchor residues. As in the class I ligands, the non-anchoring amino acids play a secondary, but still significant role (Rammensee, H., et al., (1999) Immunogenetics, 50:213-219). A number of polymorphic residues face into the peptide-binding groove of the MHC molecule. The identity of the residues lining each of the peptide-binding pockets of each MHC molecule determines its peptide binding specificity. Conversely, the sequence of a peptide determines its affinity for each MHC allele.

Several methods of identifying MHC-binding agretopes in protein sequences are known in the art and may be used, including but not limited to, those described in a recent review (Schirle et al. J. Immunol. Meth. 257:1-16 (2001)) and those described below.

In one embodiment, structure-based methods are used. For example, methods may be used in which a given peptide is computationally placed in the peptide-binding groove of a given MHC molecule and the interaction energy is determined (for example, see WO 98/59244 and WO 02/069232). Such methods may be referred to as “threading” methods.

Alternatively, purely experimental methods may be used. Examples of physical methods include high affinity binding assays (Hammer, J., et al. (1993) Proc. Natl. Acad. Sci. USA, 91:4456-4460; Sarobe, P. et al. (1998) J. Clin. Invest., 102:1239-1248), T cell proliferation and CTL assays (WO 02/77187, Hemmer, B., et al., (1998) J. Immunol., 160:3631-3636); stabilization assays, competitive inhibition assays to purified MHC molecules or cells bearing MHC, or elution followed by sequencing (Brusic, V., et al., (1998) Nucleic Acids Res., 26:368-371).

In a preferred embodiment, potential MHC II binding sites are identified by matching a database of published motifs, such as SYFPEITHI (Rammensee, H., et al., (1999) Immunogenetics, 50:213-219; (134.2.96.221 /scripts/MHCServer.dll/home.html) or (wehih.wehi.edu.au/mhcpep), or MHCPEP (Brusic, B., et al., supra).

Sequence-based rules for identifying MHC II binding sites, including but not limited to matrix method calculations, have been described in Sturniolo, T, et al. Nat. Biotechnol., 17:555-561 (1999); Hammer, J. et al., Behring. Inst. Mitt., 94: 124-132 (1994); Hammer, J. et al., J. Exp. Med., 180:2353-2358 (1994); Mallios, R. R J. Com. Biol., 5:703-711. (1998); Brusic, V., et al., Bioinformatics, 14:121-130 (1998); Mallios, R. R. Bioinformatics, 15:432-439 (1999); Marshall, K. W., et al., J. Immunology, 154:5927-5933 (1995); Novak, E. J., et al., J. Immunology, 166:6665-6670 (2001); Cochlovius, B., et al., J. Immunology, 165:4731-4741 (2000); and by Fikes, J., et al., WO 01/41788).

In an especially preferred embodiment, the matrix method is used to calculate MHC-binding propensity scores for each peptide of interest binding to each allele of interest. The matrix comprises binding scores for specific amino acids interacting with the peptide binding pockets in different human class II MHC molecule. It is possible to consider all of the residues in each 9-mer window; it is also possible to consider scores for only a subset of these residues, or to consider also the identities of the peptide residues before and after the 9-residue frame of interest. The scores in the matrix may be obtained from experimental peptide binding studies, and, optionally, matrix scores may be extrapolated from experimentally characterized alleles to additional alleles with identical or similar residues lining that pocket. Matrices that are produced by extrapolation are referred to as “virtual matrices”. (See Sturniolo, T., Bono, E., Ding, J., Raddrizzani, L., Tuereci, O., Sahin, U., Braxenthaler, M., Gallazzi, F., Protti, M. P., Sinigaglia, F., and Hammer, J. (1999) “Generation of tissue-specific and promiscuous HLA ligand databases using DNA micro arrays and virtual HLA class II matrices” Nat. Biotech., 17, 555-61 (1999).)

Several methods may then be used to determine whether a given peptide will bind with significant affinity to a given MHC allele. In one embodiment, the binding score for the peptide of interest is compared with the binding propensity scores of a large set of reference peptides. Peptides whose binding propensity scores are large compared to the reference peptides are likely to bind MHC and may be classified as “hits”. For example, if the binding propensity score is among the highest 1% of possible binding scores for that allele, it may be scored as a “hit” at the 1% threshold. The total number of hits at one or more threshold values is calculated for each peptide. In some cases, the binding score may directly correspond with a predicted binding affinity. Then, a hit may be defined as a peptide predicted to bind with at least 100 μM or 1 μM or 100 nM affinity.

In a preferred embodiment, the number of hits for each 9-mer frame in the protein is calculated using one or more threshold values ranging from 0.5% to 10%. In an especially preferred embodiment, the number of hits is calculated using 1%, 3%, and 5% thresholds.

In a preferred embodiment, MHC-binding epitopes are identified as the 9-mer frames that bind to several class II MHC alleles. In an especially preferred embodiment, MHC-binding epitopes are predicted to bind at least 10 alleles at 5% threshold and/or at least 5 alleles at 1% threshold. Such 9-mer frames may be especially likely to elicit an immune response in many members of the human population.

In a preferred embodiment, MHC-binding epitopes are predicted to bind MHC alleles that are present in at least 0.01-10% of the human population. Alternatively, to treat conditions that are linked to specific class II MHC alleles, MHC-binding epitopes are predicted to bind MHC alleles that are present in at least 0.01-10% of the relevant patient population.

Data about the prevalence of different MHC alleles in different ethnic and racial groups has been acquired by groups such as the National Marrow Donor Program (NMDP); for example see Mignot et al. Am. J. Hum. Genet. 68: 686-699 (2001), Southwood et al. J. Immunol. 160: 3363-3373 (1998), Hurley et al. Bone Marrow Transplantation 25: 136-137 (2000), Sintasath Hum. Immunol. 60: 1001 (1999), Collins et al. Tissue Antigens 55: 48 (2000), Tang et al. Hum. Immunol. 63: 221 (2002), Chen et al. Hum. Immunol. 63: 665 (2002), Tang et al. Hum. Immunol. 61: 820 (2000), Gans et al. Tissue Antigens 59: 364-369, and Baldassarre et al. Tissue Antigens 61: 249-252 (2003).

In a preferred embodiment, MHC binding epitopes are predicted for MHC heterodimers comprising highly prevalent MHC alleles. Class II MHC alleles that are present in at least 10% of the US population include but are not limited to: DPA1*0103, DPA1*0201, DPB1*0201, DPB1*0401, DPB1*0402, DQA1*0101, DQA1*0102, DQA1*0201, DQA1*0501, DQB1*0201, DQB1*0202, DQB1*0301, DQB1*0302, DQB1*0501, DQB1*0602, DRA*0101, DRB1*0701, DRB1*1501, DRB1*0301, DRB1*0101, DRB1*1101, DRB1*1301, DRB3*0101, DRB3*0202, DRB4*0101, DRB4*0103, and DRB5*0101.

In a preferred embodiment, MHC binding epitopes are also predicted for MHC heterodimers comprising moderately prevalent MHC alleles. Class II MHC alleles that are present in 1% to 10% of the US population include but are not limited to: DPA1*0104, DPA1*0302, DPA1*0301, DPB1*0101, DPB1*0202, DPB1*0301, DPB1*0501, DPB1*0601, DPB1*0901, DPB1*1001, DPB1*1101, DPB1*1301, DPB1*1401, DPB1*1501, DPB1*1701, DPB1*1901, DPB1*2001, DQA1*0103, DQA1*0104, DQA1*0301, DQA1*0302, DQA1*0401, DQB1*0303, DQB1*0402, DQB1*0502, DQB1*0503, DQB1*0601, DQB1*0603, DRB1*1302, DRB1*0404, DRB1*0801, DRB1*0102, DRB1*1401, DRB1*1104, DRB1*1201, DRB1*1503, DRB1*0901, DRB1*1601, DRB1*0407, DRB1*1001, DRB1*1303, DRB1*0103, DRB1*1502, DRB1*0302, DRB1*0405, DRB1*0402, DRB1*1102, DRB1*0803, DRB1*0408, DRB1*1602, DRB1*0403, DRB3*0301, DRB5*0102, and DRB5*0202.

MHC binding epitopes may also be predicted for MHC heterodimers comprising less prevalent alleles. Information about MHC alleles in humans and other species can be obtained, for example, from the IMGT/HLA sequence database (ebi.ac.uk/imgt/hla/).

In an additional preferred embodiment, MHC-binding epitopes are identified as the 9-mer frames that are located among “nested” epitopes, or overlapping 9-residue frames that are each predicted to bind a significant number of alleles. Such sequences may be especially likely to elicit an immune response.

Identification of T-Cell Epitopes

T -cell epitopes overlap with MHC agretopes, as TCRs recognize peptides that are bound to MHC molecules. Accordingly, methods for the identification of MHC agretopes may also be used to identify T-cell epitopes, and similarly the methods described below for the identification of T-cell epitopes may also be used to identify MHC agretopes.

TCRs occur as either of two distinct heterodimers, aβ or ?d, both of which are expressed with the non- polymorphic CD3 polypeptides ?, d, e, ?. The CD3 polypeptides, especially ? and its variants, are critical for intracellular signaling. The aβ TCR heterodimer expressing cells predominate in most lymphoid compartments and are responsible for the classical helper or cytotoxic T cell responses. In most cases, the aβ TCR ligand is a peptide antigen bound to a class I or a class II MHC molecule (Fundamental Immunology, 4th edition, W. E. Paul, ed., Lippincott-Raven Publishers, 1999, Chapter 10, pp 341-367).

Preferably, potential T-cell epitopes will be identified by matching a database of published motifs (Walden, P., (1996) Curr. Op. Immunol., 8:68-74). Other methods of identifying T-cell epitopes which are useful in the present invention include those described by Hemmer, B., et al. (1998) J. Immunol., 160:3631-3636; Walden, P., et al. (1995) Biochemical Society Transactions, 23; Anderton, S. M., et al., (1999) Eur. J. Immunol., 29:1850-1857; Correia-Neves, M., et al., (1999) J. Immunol., 163:5471-5477; Shastri, N., (1995) Curr. Op. Immunol., 7:258-262; Hiemstra, H. S., (2000) Curr. Op. Immunol., 12:80-84; and Meister, G. E., et al., (1995) Vaccine, 13:581-591).

Identification of Antibody Epitopes

Antibody epitopes may be identified using any of a number of computational or experimental approaches. As is known in the art, antibody epitopes typically possess certain structural features, such as solvent accessibility, flexibility, and the presence of large hydrophobic or charged residues. Computational methods have been developed to predict the location of antibody epitopes based on sequence and structure (Parker et. al. Biochem. 25: 5425-5432 (1986) and Kemp et. al. Clin. Exp. Immunol. 124: 377-385 (2001)). Experimental methods such as NMR and crystallography may be used to map antigen-antibody contacts. Also, mass spectrometry approaches have been developed (Spencer et. al. Proteomics 2: 271-279 (2002)). It is also possible to use mutagenesis-based approaches, in which changes in the antibody binding affinity of one or more mutant proteins is used to identify residues that confer antibody binding affinity.

Confirmation of Immunogenic Sequences

In a preferred embodiment, if computational methods were used to identify one or more immunogenic sequences, experimental methods are used to confirm the immunogenicity of the identified sequences prior to proceeding with the identification of variant proteins with modified immunogenicity. A number of methods, including but not limited to those described in Stickler et al. J. Immunol. 23: 654-660 (2000) and below in the section “Assaying the immunogenicity of the variants” may be used. However, this step is not required.

Identifying Variants with Desired Immunological Properties

Variant proteins with reduced or enhanced immunogenicity, relative to the parent protein, may be generated by introducing modifications including but not limited to those described below. In general, methods for reducing immunogenicity will find use in the development of safer and more effective protein therapeutics, while methods for increasing immunogenicity will find use in the development of more effective protein vaccines.

Enhancing APC Uptake

In a preferred embodiment, the parent protein is modified to enhance uptake by APCs. This may be accomplished by increasing the oligomerization state or effective size of the protein. For example, covalent linkage to synthetic microspheres or other particulate matter may be used to enhance APC uptake (Gengoux and Leclerc, Int. Immunol. 7: 45-53 (1995)). Alternatively, liposome encapsulation of the protein antigen may be used to induce fusion with APC membrane and enhance uptake. Alternatively, uptake may be enhanced by adding one or more binding motifs that are recognized by receptors present on the surface of APCs. It is also possible to add a motif that will be recognized by antibodies, which then interact with Fc receptors on APCs (Celis E. et al. Proc Natl Acad Sci USA, 81: 6846-6850 (1984)).

Reducing APC Uptake

In a preferred embodiment, the parent protein is modified to reduce uptake by APCs. This may be accomplished by improving solubility or by modifying one or more sites on the protein that are recognized by receptors present on the surface of the APC.

Computational protein design approaches for improving the solubility of proteins have been described previously; see for example U.S. Ser. No. 10/338785, filed Jan. 6, 2003; 10/611,363, filed Jul. 3, 2003; U.S. Ser. No. 10/676,705, filed Sep. 30, 2003; PCT US/03/00393, filed Jan. 6, 2003; and PCT US/03/30802, filed Sep. 30, 2003.

Methods for sterically blocking interactions between protein therapeutics and APC cell-surface receptors have also been disclosed previously, see 60/456094, filed Mar. 20, 2003.

Altering Antigen Processing

In a preferred embodiment, specific cleavage motifs for antigen processing and presentation are added or removed to increase the availability of one or more MHC agretopes for MHC binding. For example, it may be possible to decrease immunogenicity by adding a cleavage site within an immunogenic 9-mer peptide, since proteolysis of the 9-mer will substantially limit its ability to bind MHC molecules. As described above, a number of methods may be used to identify cleavage sites for proteases in the class I or class II pathways.

Incorporating New Class I MHC Agretopes

In a preferred embodiment, potential MHC class I agretopes are added to a target protein as a means of inducing cellular immunity. Suitable sequences may be identified using any of the methods described above for the identification of class I MHC agretopes; sequences that are predicted to have enhanced binding affinity for one or more alleles may confer increased immunogenicity. Preferably at least one MHC class I binding site is added per target protein. More preferably at least 2 MHC class I binding sites are added per target protein. More preferably between 3 to 5 MHC class I binding sites are added per target protein. In other embodiments, up to 16 MHC class I binding sites may be added per target protein (see Stienekemeier, M., et al., (2001) Proc Natl Acad Sci USA, 98:13872-13877).

New MHC agretopes can be incorporated into the parent protein in any region. In a preferred embodiment, the location of the new agretope is selected to minimize the number of mutations that must be introduced in order to confer the desired increase in immunogenicity. In an alternate preferred embodiment, the location of the new agretope is selected to minimize structural disruption. For example, the new agretope may be incorporated at the N- or C-terminus or within a loop region.

In one embodiment, for one or more sites of class I agretope addition identified above, one or more possible alternate 8-mer or 9-mer sequences is analyzed for immunogenicity. The preferred alternate sequences are then defined as those sequences that have high predicted immunogenicity. In a preferred embodiment, more immunogenic variants of each agretope exhibit increased binding affinity for at least one class I MHC allele. In an especially preferred embodiment, the more immunogenic variant of each agretope is predicted to bind to MHC alleles that are present in more than 10% of the relevant patient population, with more than 25% or 50% being most preferred.

Removing Class I MHC Agretopes

In a preferred embodiment, potential MHC class I binding sites will be modified to reduce or eliminate peptide binding to MHC class I molecules. This may be accomplished by modifying the anchor residues or the non-anchor residues. Suitable sequences may be identified using any of the methods described above for the identification of class I MHC agretopes; sequences that are predicted to have reduced binding affinity for one or more alleles may confer reduced immunogenicity.

In one embodiment, for one or more class I agretopes identified above, one or more possible alternate 8-mer or 9-mer sequences is analyzed for immunogenicity. The preferred alternate sequences are then defined as those sequences that have low predicted immunogenicity. In a preferred embodiment, less immunogenic variants of each agretope exhibit reduced binding affinity for at least one class I MHC allele. In an especially preferred embodiment, the less immunogenic variant of each agretope is predicted to bind to MHC alleles that are present in not more than 10% of the relevant patient population, with not more than 1% or 0.1% being most preferred.

Incorporating Class II MHC Agretopes

In a preferred embodiment, potential MHC class II agretopes are added to a target protein as a means of inducing humoral immunity. Suitable sequences may be identified using any of the methods described above for the identification of class II MHC agretopes; sequences that are predicted to have enhanced binding affinity for one or more alleles may confer increased immunogenicity. Preferably at least one MHC class II binding site is added per target protein. More preferably at least 2 MHC class II binding sites are added per target protein. More preferably between 3 to 5 MHC class II binding sites are added per target protein. In other embodiments, up to 16 MHC class I binding sites may be added per target protein (see Stienekemeier, M., et al., (2001) Proc Natl Acad Sci USA, 98:13872-13877).

New MHC agretopes can be incorporated into the parent protein in any region. In a preferred embodiment, the location of the new agretope is selected to minimize the number of mutations that must be introduced in order to confer the desired increase in immunogenicity. In an alternate preferred embodiment, the location of the new agretope is selected to minimize structural disruption. For example, the new agretope may be incorporated at the N- or C-terminus or within a loop region.

In one embodiment, for one or more sites of class I agretope addition identified above, one or more possible alternate 8-mer or 9-mer sequences is analyzed for immunogenicity. The preferred alternate sequences are then defined as those sequences that have high predicted immunogenicity. In a preferred embodiment, more immunogenic variants of each agretope exhibit increased binding affinity for at least one class II MHC allele. In an especially preferred embodiment, the more immunogenic variant of each agretope is predicted to bind to MHC alleles that are present in more than 10% of the relevant patient population, with more than 25% or 50% being most preferred.

Removing Class II MHC Agretopes

In a preferred embodiment, one or more of the above-determined class II MHC-binding agretopes are replaced with alternate amino acid sequences to generate variant proteins with reduced immunogenicity. Either anchoring residues, non-anchoring residues, or both may be replaced.

In one embodiment, for one or more class II agretopes identified above, one or more possible alternate 9-mer sequences is analyzed for immunogenicity. The preferred alternate sequences are then defined as those sequences that have low predicted immunogenicity. In a preferred embodiment, less immunogenic variants of each agretope exhibit reduced binding affinity for at least one class II MHC allele. In an especially preferred embodiment, the less immunogenic variant of each agretope is predicted to bind to MHC alleles that are present in not more than 10% of the relevant patient population, with not more than 1% or 0.1% being most preferred.

Incorporating T-Cell Epitope Antagonists

In a preferred embodiment, synthetic amino acids or amino acid analogs are incorporated to generate MHC class I or class II ligands with antagonistic properties. Such peptides may be recognized by T cells, but instead of eliciting an immune response, act to block immune responses to the cognate epitope. Generally, antagonists are derived from known epitopes by amino acid replacements that introduce charge or bulky size modification of peptide side chains. Preferably, N-hydroxylated peptide derivatives, or β-amino acids are introduced into T-cell epitopes to generate antagonists (see for example, Hin, S., et al., (1999) J. Immunology, 163:2363-2367; Reinelt, S., et al., (2001) J. Biol. Chem., 276:24525-24530).

Removing Antibody Epitopes

Rules for determining suitable replacements of antibody binding surface residues are emerging (see Meyer, D. L., et al. (2001) Protein Science, 10:491-503; Laroche, Y., (2000) Blood, 96:1425-1432; and Schwartz, H. L., (1999) J. Mol. Biol., 287:983-999). For example, aromatic surface residues such as tyrosine are often implicated in antigen-antibody binding. In a preferred embodiment, aromatic and charged residues in an antibody epitope may be replaced with smaller neutral residues, such as serine, threonine, asparagine, alanine or glycine.

Sterically Blocking Antibody Binding

Covalent derivatization of the parent protein, for example PEGylation, may be used to sterically interfere with antibody binding. In a preferred embodiment, the site of PEG addition is selected to be within 10 Å of at least one residue in an antibody epitope, with less than 5 Å being especially preferred. Furthermore, the size and branching structure of the PEG molecule may be selected to most effectively interfere with antibody binding. For example, branched PEG molecules may be more effective for immunogenicity reduction than linear PEG molecules of the same molecular weight (Caliceti and Veronese, Adv. Drug. Deliv. Rev. 55: 1261-1277 (2003)).

Identifying Variants with Desired Functional Properties

Modifications, such as those introduced to modulate immunogenicity, may negatively impact function in a number of ways. Mutations may directly reduce function, for example by reducing receptor binding affinity. Mutations may also reduce function indirectly by reducing the stability or solubility of the protein. Similarly, mutations may alter bioavailability. Modifications such as PEGylation may also reduce function by interfering with the formation of desired intermolecular interactions. Accordingly, in a preferred embodiment, protein stability and solubility are considered in the course of identifying variants with desired functional properties.

Two basic strategies may be used to identify variants that are likely to possess desired functional properties. If sufficient biochemical and structural data is available to directly model relevant functional properties of the parent protein and the variant proteins. For example, if binding with high affinity to a particular receptor is a desired function, energy calculations may be performed on the complex structure in order to determine whether the variant protein has decreased binding affinity. More commonly, modifications interfere with protein function by destabilizing the protein structure. Accordingly, in a preferred embodiment, the variant protein is computationally analyzed to determine whether it is likely to assume substantially the same structure as the target protein and whether the variant protein is likely to retain sufficient stability to perform the desired functions.

Structure-Based Methods

In the most preferred embodiment, structure based methods are used to identify variant sequences that are capable of stably assuming a structure that is substantially similar to the structure of the parent protein. In addition, it is preferred that structure based methods are also used to identify variant sequences that retain binding affinity for desired molecules.

Especially favored structure-based methods calculate scores or energies that report the suitability of different variant protein sequences for a target protein structure. In many cases, these methods enable the computational screening of a very large number of variant protein sequences and variant protein structures (in cases where different side chain conformations are explicitly considered). See, for example, (Dahiyat and Mayo, Protein Sci 5(5): 895-903 (1996); Dahiyat and Mayo, Science 278(5335): 82-7 (1997); Desjarlais and Handel, Protein Science 4: 2006-2018 (1995); Harbury et al, PNAS USA 92(18): 8408-8412 (1995); Kono et al., Proteins: Structure, Function and Genetics 19: 244-255 (1994); Hellinga and Richards, PNAS USA 91: 5803-5807 (1994)). It is also possible to use statistical methods, including but not limited to those that assess the suitability of different amino acid residues for specific structural contexts (Bowie and Eisenberg, Science 253(5016): 164-70, (1991)), or “residue pair potentials” that score pairs of interacting residues based on the frequency of similar interactions in proteins of known structure (Miyazawa et al., Macromolecules 18(3): 534-552 (1985) Jones, Protein Sci 3: 567-574, (1994); PROSA (Heindlich et al., J. Mol. Biol. 216:167-180 (1990); THREADER (Jones et al., Nature 358:86-89 (1992).

In an especially preferred embodiment, Protein Design Automation® (PDA®) technology is used to identify variant proteins with desired functional properties. (See U.S. Pat. Nos. 6,188,965; 6,269,312; 6,403,312; WO98/47089 and U.S. Ser. Nos. 09/058,459, 09/714,357, 09/812,034, 09/827,960, 09/837,886, 09/877,695,10/071,85909/419,351, 09/782,004 and 09/927,790, 60/347,772, 10/101,499, and 10/218,102; and PCT/US01/218,102 and U.S. Ser. No.10/218,102, U.S. Ser. No.60/345,805; U.S. Ser. No.60/373,453 and U.S. Ser. No.60/374,035). PDA® calculations may be used to identify protein sequences that are likely to be stable and adopt a given fold. In addition, PDA® calculations may be used to predict the binding affinity of a given protein for one or more binding partners, including but not limited to other proteins, sugars, small molecules, or nucleic acids.

In a preferred embodiment, the PDA® energy of the variant protein is increased by no more than 10% relative to the parent protein, with equal energies or more favorable energies being especially preferred. Similarly, if PDA® calculations are performed to determine the affinity of an intermolecular interaction, it is preferred that the interaction energy for the variant protein is increased by no more than 10%, and equal energies or more favorable energies are especially preferred.

Sequence-Based Methods

In an alternate embodiment, substitution matrices or other knowledge-based scoring methods are used to identify alternate sequences that are likely to retain the structure and function of the wild type protein. The substitution matrices may be general protein substitution matrices such as PAM or BLOSUM, or may be derived for a given protein family of interest. Such scoring methods can be used to quantify how conservative a given substitution or set of substitutions is. In most cases, conservative mutations do not significantly disrupt the structure and function of proteins (see for example, Bowie et al. Science 247: 1306-1310 (1990), Bowie and Sauer, Proc. Nat. Acad. Sci. USA 86: 2152-2156 (1989), and Reidhaar-Olson and Sauer Proteins 7: 306-316 (1990)). However, non-conservative mutations can destabilize protein structure and reduce activity (see for example, Lim et. al. Biochem. 31: 4324-4333 (1992)). Substitution matrices provide a quantitative measure of the compatibility between a sequence and a target structure, which can be used to predict non-disruptive substitution mutations (see Topham et al. Prot. Eng. 10: 7-21 (1997)). The use of substitution matrices to design peptides with improved properties has been disclosed; see Adenot et al. J. Mol. Graph. Model. 17: 292-309 (1999).

In a preferred embodiment, substitution mutations are preferentially introduced at positions that are substantially solvent exposed. As is known in the art, solvent exposed positions are typically more tolerant of mutation than positions that are located in the core of the protein.

In a preferred embodiment, substitution mutations are preferentially introduced at positions that are not highly conserved. As is known in the art, positions that are highly conserved among members of a protein family are often important for protein function, stability, or structure, while positions that are not highly conserved often can be modified without significantly impacting the structural or functional properties of the protein.

Identifying Compensatory Mutations

One special application of computational protein design algorithms is the identification of additional mutations that compensate for modifications that were introduced to modulate immunogenicity. For example, a mutation that greatly reduces immunogenicity may be destabilizing to the protein structure. Computational protein design methods may be used to identify additional mutations that will stabilize the protein. Similarly, if a modification made to reduce immunogenicity reduces receptor binding affinity, computational protein design methods may be used to identify mutations that confer increased receptor binding affinity.

Identifying Variants with Desired Immunological and Functional Properties

Immunogenicity considerations may be directly incorporated into computational protein design algorithms in any of a number of ways. It is possible to combine two or more of these methods, if desired.

Selection of Residue Choices for Each Variable Position

In one embodiment, immunogenicity considerations are used to influence the set of amino acids that are allowed at each variable position. For example, large hydrophobic residues may be excluded at solvent exposed positions to prevent the creation of a new antibody epitope or MHC agretope. Similarly, if a given substitution will increase binding to one or more MHC alleles, regardless of the residues selected at the other variable positions, it may be eliminated from consideration. It is also possible to restrict residue choices to the set of residues that can act as PEG attachment sites.

Pseudo-Energies Based on MHC Binding Propensities

In one embodiment, MHC binding propensities such as those used in matrix method calculations may be treated as pseudo-energies. The resulting scoring function may be employed in the course of protein design calculations in order to promote the selection of variant proteins with desired immunological properties.

In one embodiment, the scoring function is the Predicted Immunogenicity Profile (PIP) function given below:

$$EpitopePIP = {\sum }_{alleles} [ F ( AlleleFrequency ) ] * [ S ( AlleleStrength ]$$

The scoring function for any given potential MHC epitope is weighted by two factors: 1) the population prevalence of the alleles (allele frequency), and 2) the predicted binding affinity (allele strength). Each term can be independently weighted as appropriate using the factors F and S. The PIP may be calculated for any or all of the 9-mer windows in the protein.

Incorporating MHC Binding Affinity into Monte Carlo Calculations

In an alternate embodiment, MHC binding propensities are incorporated during a Monte Carlo calculation. Monte Carlo calculations are often performed during the course of protein design calculations in order to identify one or more sequences that have favorable energies or scores. The calculation may be modified by assessing the number and strength of predicted MHC agretopes in each sequence, and favoring steps that decrease (or increase, if immunogenicity enhancement is the goal) the predicted number or strength of the MHC agretopes.

Incorporating MHC Binding Affinity into Dead-End Elimination Calculations

In an alternate embodiment, MHC binding propensities are incorporated during a DEE calculation. DEE calculations are often performed during the course of protein design calculations in order to identify the variant sequence that has the most favorable energy or score. Typically, DEE requires energy terms that are pairwise decomposable, meaning that they depend on the identity of two residues only. Properties such as MHC binding affinity that depend on the identity of three or more residues may be incorporated into DEE during the “Unification” step. The “Unification” step combines two rotamers into one “superrotamer”, and eliminates superrotamers with unfavorable scores or energies. Similarly, superrotamers comprising one or more MHC agretopes may be eliminated.

Incorporating MHC Binding Affinity into Branch and Bound Calculations

In an alternate embodiment, MHC binding propensities are incorporated during a Branch and Bound calculation. Branch and Bound calculations are often performed during the course of protein design calculations in order to identify one or more sequences that have favorable energies or scores. Potential sequences are constructed one residue at a time. If it can be demonstrated that all sequences comprising a given partial sequence have energies or scores that are worse than some cutoff value, a “bound” is placed on that partial sequence and it is not considered further. Similarly, if it can be demonstrated that all sequences comprising a given partial sequence comprise immunogenic MHC agretopes, the partial sequence may be bound.

Additional Modifications

Additional insertions, deletions, and substitutions may be incorporated into the variant proteins of the invention in order to confer other desired properties.

In one embodiment, additional modifications are introduced to alter properties such as stability, solubility, and receptor binding affinity. Such modifications can also contribute to immunogenicity reduction. For example, since protein aggregates have been observed to be more immunogenic than soluble proteins, modifications that improve solubility may reduce immunogenicity (see for example Braun et. al. Pharm. Res. 14: 1472 (1997) and Speidel et. al. Eur. J. Immunol. 27: 2391 (1997)).

Glycosylation

In one embodiment, the sequence of the variant protein is modified in order to add or remove one or more N-linked or O-linked glycosylation sites. Addition of glycosylation sites to variant proteins may be accomplished by the incorporation of one or more serine or threonine residues to the native sequence or variant protein (for O-linked glycosylation sites) or by the incorporation of a canonical N-linked glycosylation site, including but not limited to, N-X-Y, where X is any amino acid except for proline and Y is preferably threonine, serine or cysteine. Glycosylation sites may be removed by replacing one or more serine or threonine residues or by replacing one or more canonical N-linked glycosylation sites.

In another preferred embodiment, cysteines or other reactive amino acids are designed into the variant proteins in order to incorporate labeling sites or PEGylation sites.

Cyclization and Circular Permutation

In another preferred embodiment, the N- and C-termini of a variant protein are joined to create a cyclized or circularly permutated protein. Various techniques may be used to permutate proteins. See U.S. Pat. No. 5,981,200; Maki K, Iwakura M., Seikagaku. 2001 January; 73(1): 42-6; Pan T., Methods Enzymol. 2000; 317:313-30; Heinemann U, Hahn M., Prog Biophys Mol Biol. 1995; 64(2-3): 121-43; Harris M E, Pace N R, Mol Biol Rep. 1995-96; 22(2-3): 115-23; Pan T, Uhlenbeck O C., Mar 30, 1993; 125(2): 111-4; Nardulli A M, Shapiro D J. 1993 Winter; 3(4):247-55, EP 1098257 A2; WO 02/22149; WO 01/51629; WO 99/51632; Hennecke, et al., 1999, J. Mol. Biol., 286, 1197-1215; Goldenberg et al J. Mol. Biol 165, 407-413 (1983); Luger et al, Science, 243, 206-210 (1989); and Zhang et al., Protein Sci 5, 1290-1300 (1996); all hereby incorporated by reference.

To produce a circularly permuted variant protein, a novel set of N- and C-termini are created at amino acid positions normally internal to the protein's primary structure, and the original N- and C- termini are joined via a peptide linker consisting of from 0 to 30 amino acids in length (in some cases, some of the amino acids located near the original termini are removed to accommodate the linker design). In a preferred embodiment, the novel N- and C-termini are located in a non-regular secondary structural element, such as a loop or turn, such that the stability and activity of the novel protein are similar to those of the original protein. The circularly permuted variant protein may be further PEGylated or glycosylated. In a further preferred embodiment PDA® technology may be used to further optimize the variant protein, particularly in the regions created by circular permutation. These include the novel N- and C-termini, as well as the original termini and linker peptide.

In addition, a completely cyclic variant protein may be generated, wherein the protein contains no termini. This is accomplished utilizing intein technology. Thus, peptides can be cyclized and in particular inteins may be utilized to accomplish the cyclization.

Tags and Fusion Constructs

Variant proteins of the present invention may also be modified to form chimeric molecules comprising a variant protein fused to another, heterologous polypeptide or amino acid sequence.

Variant proteins of the present invention may also be fused to another, heterologous polypeptide or amino acid sequence to form a chimera. The chimeric molecule may comprise a fusion of a variant protein with an immunoglobulin or a particular region of an immunoglobulin such as the Fc or Fab regions of an IgG molecule. In another embodiment, the variant protein is fused with human serum albumin to improve pharmacokinetics.

In an alternative embodiment, the chimeric molecule comprises a variant protein and a tag polypeptide which provides an epitope to which an anti-tag antibody can selectively bind. The epitope tag is generally placed at the amino-or carboxyl-terminus of the variant protein. The presence of such epitope-tagged forms of a variant protein can be detected using an antibody against the tag polypeptide. Also, provision of the epitope tag enables the variant protein to be readily purified by affinity purification using an anti-tag antibody or another type of affinity matrix that binds to the epitope tag. Various tag polypeptides and their respective antibodies are well known in the art. Examples include poly-histidine (poly-His) or poly-histidine-glycine (poly-His-Gly) tags; the flu HA tag polypeptide and its antibody 12CA5 [Field et al., Mol. Cell. Biol. 8:2159-2165 (1988)]; the c-myc tag and the 8F9, 3C7, 6E10, G4, B7 and 9E10 antibodies thereto [Evan et al., Molecular and Cellular Biology, 5:3610-3616 (1985)]; and the Herpes Simplex virus glycoprotein D (gD) tag and its antibody [Paborsky et al., Protein Engineering, 3(6): 547-553 (1990)]. Other tag polypeptides include the Flag-peptide [Hopp et al., Bio Technology 6:1204-1210 (1988)]; the KT3 epitope peptide [Martin et al., Science 255:192-194 (1992)]; tubulin epitope peptide [Skinner et al., J. Biol. Chem. 266:15163-15166 (1991)]; and the T7 gene 10 protein peptide tag [Lutz-Freyermuth et al., Proc. Natl. Acad. Sci. U.S.A. 87:6393-6397 (1990)].

Generating Variants

Variant proteins of the invention and nucleic acids encoding them may be produced using a number of methods known in the art.

Generating Nucleic Acid Encoding the Variant Protein

In a preferred embodiment, nucleic acids encoding the variant proteins are prepared by total gene synthesis or by site-directed mutagenesis of a nucleic acid encoding a parent protein. Methods including template-directed ligation, recursive PCR, cassette mutagenesis, site-directed mutagenesis or other techniques that are well known in the art may be utilized (see for example Strizhov et al. PNAS 93:15012-15017 (1996), Prodromou and Perl, Prot. Eng. 5: 827-829 (1992), Jayaraman and Puccini, Biotechniques 12: 392-398 (1992), and Chalmers et al. Biotechniques 30: 249-252 (2001)).

Protein Expression

Appropriate host cells for the expression of the variant proteins include yeast, bacteria, archaebacteria, fungi, and insect and animal cells, including mammalian cells. Of particular interest are bacteria such as E. coli and Bacillus subtilis, fungi such as Saccharomyces cerevisiae, Pichia pastoris, and Neurospora, insects such as Drosophila melangaster and insect cell lines such as SF9, mammalian cell lines including 293, CHO, COS, Jurkat, NIH3T3, etc. (see the ATCC cell line catalog). The variant proteins of the present invention may be produced by culturing a host cell transformed with an expression vector containing nucleic acid encoding a variant protein, under the appropriate conditions to induce or cause expression of the variant protein. The conditions appropriate for variant protein expression will vary with the choice of the expression vector and the host cell, and will be easily ascertained by one skilled in the art through routine experimentation. For example, the use of constitutive promoters in the expression vector will require optimizing the growth and proliferation of the host cell, while the use of an inducible promoter requires the appropriate growth conditions for induction. In addition, in some embodiments, the timing of the harvest is important. For example, the baculoviral systems used in insect cell expression are lytic viruses, and thus harvest time selection can be crucial for product yield.

In a preferred embodiment, variant proteins are expressed in E. coli. Bacterial expression systems and methods for their use are well known in the art (see Current Protocols in Molecular Biology, Wiley & Sons, and Molecular Cloning—A Laboratory Manual—3rd Ed., Cold Spring Harbor Laboratory Press, New York (2001)). The choice of codons, suitable expression vectors and suitable host cells will vary depending on a number of factors, and may be easily optimized as needed. In an alternate preferred embodiment, variant proteins are expressed in mammalian cells or in other expression systems including but not limited to yeast, baculovirus, and in vitro expression systems.

In one embodiment, the variant nucleic acids, proteins and antibodies of the invention are labeled with a label other than the scaffold. By “labeled” herein is meant that a compound has at least one element, isotope or chemical compound attached to enable the detection of the compound. In general, labels fall into three classes: a) isotopic labels, which may be radioactive or heavy isotopes; b) immune labels, which may be antibodies or antigens; and c) colored or fluorescent dyes. The labels may be incorporated into the compound at any position.

Protein Purification

In a preferred embodiment, the variant proteins are purified or isolated after expression. Standard purification methods include electrophoretic, molecular, immunological and chromatographic techniques, including ion exchange, hydrophobic, affinity, and reverse-phase HPLC chromatography, and chromatofocusing. For example, a variant protein may be purified using a standard anti-recombinant protein antibody column. Ultrafiltration and diafiltration techniques, in conjunction with protein concentration, are also useful. For general guidance in suitable purification techniques, see Scopes, R., Protein Purification, Springer-Verlag, N.Y., 3rd ed. (1994). The degree of purification necessary will vary depending on the desired use, and in some instances no purification will be necessary.

Posttranslational Modification and Derivatization

Once made, the variant proteins may be covalently modified. Covalent and non-covalent modifications of the protein are thus included within the scope of the present invention. Such modifications may be introduced into a variant protein by reacting targeted amino acid residues of the protein with an organic derivatizing agent that is capable of reacting with selected side chains or terminal residues. Optimal sites for modification can be chosen using a variety of criteria, including but not limited to, visual inspection, structural analysis, sequence analysis, and molecular simulation.

In one embodiment, the variant proteins of the invention are labeled with at least one element, isotope or chemical compound. In general, labels fall into three classes: a) isotopic labels, which may be radioactive or heavy isotopes; b) immune labels, which may be antibodies or antigens; and c) colored or fluorescent dyes. The labels may be incorporated into the compound at any position. Labels include but are not limited to biotin, tag (e.g. FLAG, Myc) and fluorescent labels (e.g. fluorescein).

One type of covalent modification includes reacting targeted amino acid residues of a variant TPO polypeptide with an organic derivatizing agent that is capable of reacting with selected side chains or the N-or C-terminal residues of a variant protein. Derivatization with bifunctional agents is useful, for instance, for cross linking a variant protein to a water-insoluble support matrix or surface for use in the method for purifying anti-variant protein antibodies or screening assays, as is more fully described below. Commonly used cross linking agents include, e.g., 1,1-bis(diazoacetyl)-2-phenylethane, glutaraldehyde, N-hydroxysuccinimide esters, for example, esters with 4-azidosalicylic acid, homobifunctional imidoesters, including disuccinimidyl esters such as 3,3′-dithiobis(succinimidylpropionate), bifunctional maleimides such as bis-N-maleimido-1,8-octane and agents such as methyl-3-[(p-azidophenyl)dithio] propioimidate.

Other modifications include deamidation of glutaminyl and asparaginyl residues to the corresponding glutamyl and aspartyl residues, respectively, hydroxylation of proline and lysine, phosphorylation of hydroxyl groups of seryl or threonyl residues, methylation of the amino groups of lysine, arginine, and histidine side chains [T. E. Creighton, Proteins: Structure and Molecular Properties, W.H. Freeman & Co., San Francisco, pp. 79-86 (1983)], acetylation of the N-terminal amine, and amidation of any C-terminal carboxyl group.

Such derivatization may improve the solubility, absorption, permeability across the blood brain barrier, serum half life, and the like. Modifications of variant proteins may alternatively eliminate or attenuate any possible undesirable side effect of the protein. Moieties capable of mediating such effects are disclosed, for example, in Remington's Pharmaceutical Sciences, 16th ed., Mack Publishing Co., Easton, Pa. (1980).

Another type of covalent modification of variant proteins comprises linking the variant protein to one of a variety of nonproteinaceous polymers, e.g., polyethylene glycol (“PEG”), polypropylene glycol, or polyoxyalkylenes, in the manner set forth in U.S. Pat. Nos. 4,640,835; 4,496,689; 4,301,144; 4,670,417; 4,791,192 or 4,179,337. A variety of coupling chemistries may be used to achieve PEG attachment, as is well known in the art. Examples include but are not limited to, the technologies of Shearwater and Enzon, which allow modification at primary amines, including but not limited to, lysine groups and the N-terminus. See, Kinstler et al, Advanced Drug Deliveries Reviews, 54, 477-485 (2002) and M J Roberts et al, Advanced Drug Delivery Reviews, 54, 459-476 (2002), both hereby incorporated by reference. It is also possible to modify the variant proteins by covalently attaching a covalent polymer, for example as described in WO 0141812A2.

Assaying the Activity of the Variants

The variant proteins of the invention may be tested for activity using any of a number of methods, including but not limited to receptor binding assays, cell-based activity assays, and in vivo assays. Suitable assays will vary according to the identity of the parent protein and may easily be identified by one skilled in the art.

Assaying the Immunogenicity of the Variants

In a preferred embodiment, the immunogenicity of the variant proteins is determined experimentally to confirm that the variants do have enhanced or reduced immunogenicity, as desired, relative to the parent protein. Alternatively, the immunogenicity of a novel protein may be assessed.

Antigen Uptake Assays

Uptake of the variant proteins by APCs may be determined. There are a number of methods that can be used to assess the extent to which the variant protein is internalized within the APCs. For example, it is possible to fluorescently label the variant protein and use imaging methods to monitor uptake. It is also possible to fix APCs and stain them using a labeled antibody that recognizes the variant protein of interest (Inaba et al. J. Exp. Med. 188: 2163-2173 (1998), Mahnke et. al. J. Cell. Biol. 151: 673-683 (2000)). It is also possible to measure disappearance from media containing the cells. In an especially preferred embodiment, the subcellular localization of the antigen is determined.

MHC Binding Assays

In a preferred embodiment, the variant proteins are assayed for the presence of MHC agretopes. A number of methods may be used to measure peptide interactions with MHC, including but not limited to those described in a recent review (Fleckenstein et al. Sem. Immunol. 11: 405-416 (1999)) and those discussed below.

In one embodiment, the variant proteins may be screened for MHC binding using a series of overlapping peptides. It is possible to assay peptide-MHC binding in solution, for example by fluorescently labeling the peptide and monitoring fluorescence polarization (Dedier et al. J. Immuno. Meth. 255: 57-66 (2001)). It is also possible to use mass spectrometry methods (Lemmel and Stevanovic, Methods 29: 248-259 (2003)).

T-Cell Activation Assays

In a preferred embodiment, ex vivo T-cell activation assays are used to experimentally quantitate immunogenicity (see for example Fleckenstein supra, Schmittel et. al. J. Immunol. Meth., 24: 17-24 (2000), Anthony and Lehmann Methods 29: 260-269 (2003), Stickler et al. J. Immunother. 23: 654-660 (2000), Hoffmeister et al. Methods 29: 270-281 (2003) and Schultes and Whiteside, J. Immunol. Meth. 279: 1-15 (2003)). Any of a number of assay protocols can be used; these protocols differ regarding the mode of antigen presentation (MHC tetramers, intact APCs), the form of the antigen (peptide fragments or whole protein), the number of rounds of stimulation, and the method of detection (Elispot detection of cytokine production, flow cytometry, tritiated thymidine incorporation).

In the most preferred embodiment, APCs and CD4+ T cells from matched donors are challenged with a peptide or whole protein of interest two to five times, and T-cell activation is monitored using Elispot assays for interferon gamma production. It is preferred that the assays are repeated using a set of donors comprising most or all of the prevalent MHC alleles.

In addition, suitable assays include those disclosed in Meidenbauer, N., Harris, D. T., Spitler, L. E., Whiteside, T. L., 2000. Generation of PSA-reactive effector cells after vaccination with a PSA-based vaccine in patients with prostate cancer. Prostate 43, 88-100 and Schultes, B. C and Whiteside, T. L., 2003. Monitoring of Immune Responses to CA125 with an IFN-? ELISPOT Assay. J. Immunol. Methods 279, 1-15.

There are different ways to prime the T-cells in vitro. The antigen presenting cells (APCs) may be loaded with individual peptides, and selected T-cells tested with the same peptides. In a preferred embodiment, the T-cells can be primed with a combination of several peptides, and then tested with individual ones. In a preferred embodiment, the T-cells can be selected with multiple rounds of stimulation with APCs loaded with proteins, and then tested with individual peptides from that protein to identify physiologically relevant epitopes.

Delineating potential immunogenic T-cell epitopes within intact proteins is usually carried out by making overlapping synthetic peptides spanning the protein's sequence and using these peptides in T-cell proliferation assays (see Stickler, M M, Estell, D A, Harding, F A “CD4+ T-Cell Epitope Determination Using Unexposed Human Donor Peripheral Blood Mononuclear Cells” J. Immunotherapy, 23, 654-660 (2000), incorporated by reference). Uptake of peptides for MHC presentation by the APC is not required since sufficient empty MHC class II molecules generally exist on the surface of most APC and bind sufficient quantity of peptide. While uptake and presentation of antigens derived from intact protein in these in vitro assays can be less efficient in the absence of receptor-mediated endocytosis, the use of intact protein is beneficial because the use of intact proteins will more closely mimic the physiological antigen processing pathway, thereby reducing the number of false immunogenic positives.

In a preferred embodiment of an IVV T-cell assay, a DNA construct will be made that includes attaching a tag (e.g, Myc, His, S-tag, Flag) to the protein. The preferred tag should itself be non-immunogenic and will have commercially available mouse monoclonal antibodies. In addition, a humanized anti-tag antibody is used. The humanized anti-tag antibody is generated preferably by grafting the mouse variable regions onto a human IgG scaffold or by removing T-helper cell epitopes. The protein-tag-antibody complex will be introduced into a CD4(+) T-cell assay in which the complex will target an antigen presenting cell (APC: e.g., dendritic cell or macrophage) via cell surface Fc? receptors.

Protein antigen interaction with certain receptors (e.g., mannose receptor; Tan M C, Mommaas A M, Drijfhout J W, Jordens R, Onderwater J J, Verwoerd D, Mulder M, van der Heiden A N, Ottenhoff T H, Celia M, TuIp A, Neefjes J J, Koning F. “Mannose receptor mediated uptake of antigens strongly enhances HLA-class II restricted antigen presentation by cultured dentritic cells” Adv Exp Med Biol, 417, 171-4 (1997); incorporated by reference) on the surface of APC increases the efficiency of protein antigen uptake. The most common professional APC in humans, dendritic cells and macrophages, display surface Fc receptors, which specifically bind to the Fc portion of IgG. By coupling a protein tag and an antibody specific for that tag, antibody-mediated targeting (Celis E, Zurawski V R Jr, Chang T W. “Regulation of T-cell function by antibodies: enhancement of the response of human T-cell clones to hepatitis B surface antigen by antigen-specific monoclonal antibodies” Proc Natl Acad Sci USA, 81, 6846-50 (1984), incorporated by reference) of the APC may increase protein antigen uptake.

Alternatively, liposome encapsulation of protein antigen could induce fusion with APC membrane and enhance uptake.

In another preferred embodiment, reactive polyclonal T cell populations expanded after multiple rounds of re-stimulation in the presence of MHC-restricted antigen are used to map the immunodominant epitopes present within the protein of interest.

A preferred assay may be performed using the following steps: (1) Whole protein will be introduced to the antigen presenting cell (APC) and appropriate conditions found to stimulate efficient uptake and processing, (2) the APC with multiple MHC-restricted epitopes will stimulate initially naive T cells, (3) multiple rounds of T cell re-stimulation will take place to ensure a large population of reactive polyclonal T cells, (4) this pool of reactive T cells will be divided into smaller amounts, 5) potential peptide epitopes from the full length protein are synthesized based on either prediction or from an overlapping peptide library, 6) each peptide will be tested for T cell reactivity for the samples from step (4) above. The testing may use, for example, the EliSPOT method.

The present invention provides in vitro testing of T-cell activation by endogenous or foreign proteins or peptides. CD4+ T-cells are activated in vitro by repeated cycles of exposure to the antigen presenting cells loaded with whole proteins or peptides. T-cells undergo negative selection during their development to minimize the number that are reactive to self-antigens. Hence, the vast majority of naive T-cells may not be reactive to many therapeutic proteins of human origin, and in vitro immunogenicity testing in that capacity with naive T-cells may hinder the discovery of potential MHC-binding epitopes. Conditions for in vitro activation of T cells that allow multiple rounds of selection are a preferred embodiment as it allows for further optimization. Dendritic cells loaded with the test antigen are preserved frozen, and aliquots of the antigen are thawed prior to each T-cell activation. This method of the present invention allows consistency regarding the APCs used for the various cycles of T-cell activation. In a preferred embodiment, an optimized assay has been developed to test either peptides or whole proteins.

In a preferred embodiment, it is desirable to increase the population of reactive CD4+ T-cells prior to the activation assay. As is known in the art, dendritic cells may be produced from proliferating dendritic cell precursors (See for example, U.S. Ser. No. 2002/0085993, U.S. Pat. Nos. 5,994,126; 6,274,378; 5,851,756; and WO93/20185, hereby expressly incorporated by reference.). Dendritic cells pulsed with proteins or peptides are co-cultured with CD4+ T cells. Multiple rounds of T-cell proliferation in the presence of antigen presenting dendritic cells simulate in vivo clonal expansion. See for example, WO9833888, hereby expressly incorporated by reference in its entirety. The number of rounds required is empirically determined based on signaling. IVV may be used for either whole proteins or peptides. The results obtained with peptides as antigens indicated that a maturation step with cytokines is not required.

In a preferred embodiment, full length and truncated (receptor-binding domain) proteins may be tested with the preferred assay. Peptides derived from the protein sequence will also be evaluated, and the necessary number of exposures (dendritic cells vs. T cells) to obtain sufficient and measurable T-cell activation determined. The proteins/peptides will be tested with cells from several different donors (different alleles). Preferably, APCs are be dendritic cells isolated either directly from patient PBMC or differentiated from patient monocytes. Antigen-dependent activation of CD4+ T-helper cells is required prior to the sustained production of the antibody isotype most relevant to Cl.

Enzymatic processing of exogenous antigens by professional antigen presenting cells (APC) provides a pool of potentially antigenic peptides from which proteins encoded in the Major Histocompatibility Complex (MHC class II molecules) are drawn from for loading and presentation to CD4+ T cells. T cells expressing the appropriate T-cell receptor with basal affinity for the MHC/peptide complex on the APC surface activate and proliferate in response to the interaction. T cells isolated from “unprimed” individuals that have had little or no prior exposure to a particular antigen are said to be “naive”. During the development of T cells, positive and negative selection may take place. Positive selection ensures that the individual's T cell population expresses viable T-cell receptors while negative selection minimizes the number of high affinity self-reactive T cells.

For the purposes of measuring ex vivo T cell activation in response to self antigen, in vivo negative selection may hinder the measurement due to low numbers of T cells available to react and thereby lowering the confidence that any lack of T-cell activation really signifies the absence of MHC binding epitopes. Multiple rounds of T-cell re-stimulation and proliferation in the presence of antigen-loaded professional antigen presenting cells (e.g., dendritic cells) may produce an expanded polyclonal population of T cells reactive to MHC epitope(s) created by the antigen.

In Vivo Assays

In an alternate preferred embodiment, immunogenicity is measured in transgenic mouse systems. For example, mice expressing fully or partially human class II MHC molecules may be used (see for example Stewart et. al. Mol. Biol. Med. 6: 275-281 (1989), Sonderstrup et. al. Immunol. Rev. 172: 335-343 (1999) and Forsthuber et al. J. Immunol. 167:119-125 (2001)).

In another embodiment, immunogenicity is measured using mice reconstituted with human antigen-presenting cells and T cells in place of their endogenous cells (WO 98/52976; WO 00/34317).

In an alternate embodiment, immunogenicity is tested by administering the variant proteins of the invention to one or more animals, including rodents and primates, and monitoring for antibody formation. Non-human primates with defined MHC haplotypes may be especially useful, as the sequences and hence peptide binding specificities of the MHC molecules in non-human primates may be very similar to the sequences and peptide binding specificities of humans.

Formulation and Administration

Once made, the variant proteins and nucleic acids of the invention find use in a number of applications. In a preferred embodiment, the variant proteins are administered to a patient to prevent or treat a disease or disorder. Suitable diseases or disorders will vary according to the nature of the parent protein and may be determined by one skilled in the art. Administration may be therapeutic or prophylactic.

Formulation

The pharmaceutical compositions of the present invention comprise a variant protein in a form suitable for administration to a patient. In a preferred embodiment, the pharmaceutical compositions are in a water soluble form, such as being present as pharmaceutically acceptable salts, which is meant to include both acid and base addition salts. “Pharmaceutically acceptable acid addition salt” refers to those salts that retain the biological effectiveness of the free bases and that are not biologically or otherwise undesirable, formed with inorganic acids such as hydrochloric acid, hydrobromic acid, sulfuric acid, nitric acid, phosphoric acid and the like, and organic acids such as acetic acid, propionic acid, glycolic acid, pyruvic acid, oxalic acid, maleic acid, malonic acid, succinic acid, fumaric acid, tartaric acid, citric acid, benzoic acid, cinnamic acid, mandelic acid, methanesulfonic acid, ethanesulfonic acid, p-toluenesulfonic acid, salicylic acid and the like. “Pharmaceutically acceptable base addition salts” include those derived from inorganic bases such as sodium, potassium, lithium, ammonium, calcium, magnesium, iron, zinc, copper, manganese, aluminum salts and the like. Particularly preferred are the ammonium, potassium, sodium, calcium, and magnesium salts. Salts derived from pharmaceutically acceptable organic non-toxic bases include salts of primary, secondary, and tertiary amines, substituted amines including naturally occurring substituted amines, cyclic amines and basic ion exchange resins, such as isopropylamine, trimethylamine, diethylamine, triethylamine, tripropylamine, and ethanolamine.

The pharmaceutical compositions may also include one or more of the following: carrier proteins such as serum albumin; buffers such as NaOAc; fillers such as microcrystalline cellulose, lactose, corn and other starches; binding agents; sweeteners and other flavoring agents; coloring agents; and polyethylene glycol. Additives are well known in the art, and are used in a variety of formulations.

Administration of a Protein Therapeutic Using Standard Approaches

The administration of the variant proteins of the present invention, preferably in the form of a sterile aqueous solution, may be done in a variety of ways, including, but not limited to, orally, subcutaneously, intravenously, intranasally, transdermally, intraperitoneally, intramuscularly, parenterally, intrapulmonary, vaginally, rectally, or intraocularly. In some instances, for example, the variant protein may be directly applied as a solution or spray. Depending upon the manner of introduction, the pharmaceutical composition may be formulated in a variety of ways. In a preferred embodiment, a therapeutically effective dose of a variant protein is administered to a patient in need of treatment. By “therapeutically effective dose” herein is meant a dose that produces the effects for which it is administered. The exact dose will depend on the purpose of the treatment, and will be ascertainable by one skilled in the art using known techniques. In a preferred embodiment, the concentration of the therapeutically active variant protein in the formulation may vary from about 0.1 to about 100 weight %. In another preferred embodiment, the concentration of the variant protein is in the range of 0.003 to 1.0 molar. As is known in the art, adjustments for protein degradation, systemic versus localized delivery, and rate of new protease synthesis, as well as the age, body weight, general health, sex, diet, time of administration, drug interaction and the severity of the condition may be necessary, and will be ascertainable with routine experimentation by those skilled in the art.

Combinations of pharmaceutical compositions may be administered. Moreover, the compositions may be administered in combination with other therapeutics.

Administration of a Protein Therapeutic Using Gene Therapy Approaches

In an alternate embodiment, nucleic acids encoding a variant protein may be administered; i.e., “gene therapy” approaches may be used. In this embodiment, variant nucleic acids are introduced into cells in a patient in order to achieve in vivo synthesis of a therapeutically effective amount of variant protein. Variant nucleic acids may be introduced using a number of techniques, including but not limited to transfection with liposomes, viral (typically retroviral) vectors, and viral coat protein-liposome mediated transfection (Dzau et al., Trends in Biotechnology 11:205-210 (1993)). In some situations, it is desirable to provide the nucleic acid source with an agent that targets the target cells, such as an antibody specific for a cell surface membrane protein or the target cell, a ligand for a receptor on the target cell, etc. Where liposomes are employed, proteins which bind to a cell surface membrane protein associated with endocytosis may be used for targeting and/or to facilitate uptake, e.g. capsid proteins or fragments thereof tropic for a particular cell type, antibodies for proteins which undergo internalization in cycling, proteins that target intracellular localization and enhance intracellular half-life. The technique of receptor-mediated endocytosis is described (Wu et al., J. Biol. Chem. 262:4429-4432 (1987) and Wagner et al., Proc. Natl. Acad. Sci. U.S.A. 87:3410-3414 (1990)). For review of gene marking and gene therapy protocols see Anderson et al., Science 256:808-813 (1992).

Vaccine Administration

In a preferred embodiment, a variant protein of the invention is administered as a vaccine. Formulations and methods of administration described above for protein therapeutics may also be suitable for protein vaccines. It is also possible to administer variant nucleic acids of the invention as DNA vaccines, such that the variant nucleic acid provides expression of the variant protein. Naked DNA vaccines are generally known in the art (Brower, Nature Biotechnology, 16:1304-1305 (1998)). The variant nucleic acid used for DNA vaccines may encode all or part of the variant protein.

In a preferred embodiment, the vaccines comprise an adjuvant molecule. Such adjuvant molecules include any chemical entity that increases the immunogenic response to the variant polypeptide or ______ the encoded by the DNA vaccine (e.g. cytokines, pharmaceutically acceptable excipients, polymers, organic molecules, etc.).

### EXAMPLE

### Example 1

### Identification of Class II MHC-Binding Agretopes in Native Human Thrombopoietin (TPO)

In order to find class II MHC agretopes, each 9-residue fragment of native human TPO was analyzed for its propensity to bind to each of 52 class II MHC alleles for which peptide binding affinity matrices have been derived (Sturniolo, supra). The calculations were performed using cutoffs of 1%, 3%, and 5%. The number of alleles that each peptide is predicted to bind at each of these cutoffs are shown below. 9-mer peptides that are not listed below are not predicted to bind to any alleles at the 5%, 3%, or 1% cutoffs.

TABLE 1
Class II MHC agretopes in human TPO

| First | Last | 9-mer | 1% | 3% | 5% |
|---|---|---|---|---|---|
| residue | residue | sequence | Hits | Hits | Hits |
| 9 | 17 | LRVLSKLLR | 17 | 31 | 36 |
| 11 | 19 | VLSKLLRDS | 9 | 14 | 17 |
| 15 | 23 | LLRDSHVLH | 5 | 6 | 7 |
| 16 | 24 | LRDSHVLHS | 4 | 13 | 21 |
| 22 | 30 | LHSRLSQCP | 0 | 0 | 1 |
| 32 | 40 | VHPLPTPVL | 0 | 0 | 1 |
| 39 | 47 | VLLPAVDFS | 0 | 0 | 4 |
| 63 | 71 | ILGAVTLLL | 0 | 3 | 9 |
| 64 | 72 | LGAVTLLLE | 0 | 0 | 1 |
| 69 | 77 | LLLEGVMAA | 2 | 8 | 14 |
| 90 | 98 | LGQLSGQVR | 0 | 0 | 2 |
| 97 | 105 | VRLLLGALQ | 6 | 25 | 32 |
| 101 | 109 | LGALQSLLG | 0 | 0 | 1 |
| 104 | 112 | LQSLLGTQL | 1 | 2 | 2 |
| 127 | 135 | IFLSFQHLL | 0 | 2 | 2 |
| 128 | 136 | FLSFQHLLR | 0 | 3 | 6 |
| 131 | 139 | FQHLLRGKV | 0 | 3 | 6 |
| 134 | 142 | LLRGKVRFL | 0 | 0 | 1 |
| 135 | 143 | LRGKVRFLM | 17 | 18 | 21 |
| 139 | 147 | VRFLMLVGG | 0 | 5 | 21 |
| 141 | 149 | FLMLVGGST | 0 | 1 | 4 |
| 142 | 150 | LMLVGGSTL | 0 | 1 | 6 |
| 144 | 152 | LVGGSTLCV | 0 | 8 | 11 |
| 152 | 160 | VRRAPPTTA | 1 | 10 | 17 |
| 167 | 175 | LVLTLNELP | 0 | 3 | 3 |
| 171 | 179 | LNELPNRTS | 0 | 0 | 1 |
| 200 | 208 | WQQGFRAKI | 0 | 0 | 2 |
| 204 | 212 | FRAKIPGLL | 2 | 3 | 6 |
| 208 | 216 | IPGLLNQTS | 0 | 0 | 2 |
| 211 | 219 | LLNQTSRSL | 0 | 0 | 6 |
| 232 | 240 | LLNGTRGLF | 0 | 1 | 2 |
| 283 | 291 | YTLFPLPPT | 0 | 1 | 1 |
| 296 | 304 | VVQLHPLLP | 3 | 8 | 12 |
| 297 | 305 | VQLHPLLPD | 1 | 5 | 10 |
| 318 | 326 | LNTSYTHSQ | 0 | 2 | 7 |
| 322 | 330 | YTHSQNLSQ | 0 | 2 | 2 |

Based on the above analysis, the 9-mer peptides that are predicted to bind to the most MHC alleles are residues 9-17, 11-19, 16-24, 69-77, 97-105, 135-143, 139-147, 144-152, 152-150, 296-304, and 297-305.

Each 9-residue fragment of native human TPO also analyzed to determine the percent of the United States population with at least one allele that binds the 9-mer peptide. The calculations were performed using a 5% cutoff.

TABLE 2

percent population
affected by each TPO agretope

| | | | |
|---|---|---|---|
| Start | End | Sequence | % pop |

| | | | |
|---|---|---|---|
| 9 | 17 | LRVLSKLLR | 58.69% |
| 11 | 19 | VLSKLLRDS | 21.21% |
| 15 | 23 | LLRDSHVLH | 21.29% |
| 16 | 24 | LRDSHVLHS | 44.64% |
| 22 | 30 | LHSRLSQCP | 1.73% |
| 32 | 40 | VHPLPTPVL | 4.96% |
| 63 | 71 | ILGAVTLLL | 33.54% |
| 69 | 77 | LLLEGVMAA | 22.70% |
| 90 | 98 | LGQLSGQVR | 0.00% |
| 97 | 105 | VRLLLGALQ | 39.93% |
| 104 | 112 | LQSLLGTQL | 16.61% |
| 127 | 135 | IFLSFQHLL | 24.75% |
| 128 | 136 | FLSFQHLLR | 20.92% |
| 131 | 139 | FQHLLRGKV | 13.23% |
| 134 | 142 | LLRGKVRFL | 1.73% |
| 135 | 143 | LRGKVRFLM | 53.69% |
| 139 | 147 | VRFLMLVGG | 49.72% |
| 141 | 149 | FLMLVGGST | 14.02% |
| 142 | 150 | LMLVGGSTL | 37.25% |
| 144 | 152 | LVGGSTLCV | 41.37% |
| 152 | 160 | VRRAPPTTA | 25.09% |
| 167 | 175 | LVLTLNELP | 13.99% |
| 171 | 179 | LNELPNRTS | 1.73% |
| 204 | 212 | FRAKIPGLL | 5.14% |
| 208 | 216 | IPGLLNQTS | 5.94% |
| 211 | 219 | LLNQTSRSL | 16.45% |
| 232 | 240 | LLNGTRGLF | 21.29% |
| 283 | 291 | YTLFPLPPT | 2.01% |
| 296 | 304 | VVQLHPLLP | 36.88% |
| 297 | 305 | VQLHPLLPD | 19.82% |
| 318 | 326 | LNTSYTHSQ | 19.10% |
| 322 | 330 | YTHSQNLSQ | 13.99% |

Based on the above analysis, the 9-mer residues that are predicted to bind to alleles that are present at least 20% of United States population are residues 9-17, 11-19, 15-23, 16-24, 63-52, 69-77, 97-105, 127-135, 128-136, 135-143, 139-147, 142-150, 144-152, 152-160, 232-240, and 296-304.

The sequence of wild type human TPO was also compared to peptides that are known to bind human class II MHC alleles. Regions of TPO that are similar to known binders may bind to MHC molecules. The program RANKPEP (mifoundation.org/Tools/rankpep.html) was used to identify epitopes that may bind to the following human class II MHC alleles: DRB1*0101, DRB1*0301, DRB1*0401, DRB1*0701, DRB1*1101, DRB1*1301, DRB1*1501, DRB4*0101, DRB5*0101, DQA1*0101/DQB1*0501, DQA1*0501/DQB1*0201, DQA1*0102DQB1*0602, and DPA1*0201/DPB1*0901. 9-mer peptides that are similar to known MHC binders include:

TABLE 3

TPO peptides that are
similar to known MHC agretopes

| | | | |
|---|---|---|---|
| POS. | SEQUENCE | SCORE | % OPT. |

| | | | |
|---|---|---|---|
| 3 | APPACDLRV | 12 | 23.54% |
| 8 | DLRVLSKLL | 76 | 60.80% |
| 25 | RLSQCPEVH | 77 | 61.60% |
| 44 | VDFSLGEWK | 63 | 48.46% |
| 52 | KTQMEETKA | 59 | 47.20% |
| 54 | QMEETKAQD | 63 | 50.40% |
| 63 | ILGAVTLLL | 14 | 32.06% |
| 86 | LSSLLGQLS | 69 | 51.88% |
| 101 | LGALQSLLG | 61 | 45.86% |
| 104 | LQSLLGTQL | 67 | 50.38% |
| 127 | IFLSFQHLL | 9 | 21.34% |
| 128 | FLSFQHLLR | 10 | 22.62% |
| 135 | LRGKVRFLM | 10 | 14.68% |
| 139 | VRFLMLVGG | 70 | 53.85% |
| 141 | FLMLVGGST | 61 | 45.86% |
| 152 | VRRAPPTTA | 71 | 54.62% |
| 160 | AVPSRTSLV | 15 | 29.20% |
| 184 | TNFTASART | 59 | 45.38% |
| 186 | FTASARTTG | 9 | 21.32% |
| 198 | LKWQQGFRA | 18 | 27.76% |
| 199 | KWQQGFRAK | 18 | 27.37% |
| 200 | WQQGFRAKI | 11 | 16.46% |
| 215 | TSRSLDQIP | 65 | 52.00% |
| 229 | IHELLNGTR | 61 | 46.92% |
| 322 | YTHSQNLSQ | 62 | 46.62% |

These results also identify the region from residues 135-149 as being especially likely to contain MHC-binding epitopes.

### Example 2

### Identification of Less Immunogenic Variants of Epitopes 1-4

Several methods were used to generate alternate sequences for epitopes 1-4 that are predicted to confer decreased immunogenicity.

Altering the Three Residues that Contribute Most to MHC Binding

Here, the matrix method was used to identify which of the 9 amino acid positions within the epitope(s) contribute most to the overall binding propensities for each particular allele “hit”. This analysis considers which positions (P1-P9) are occupied by amino acids with propensity scores that are consistently large and positive for alleles scoring above the threshold values. The matrix method was then used to identify amino acid substitutions at said positions that would decrease or eliminate predicted immunogenicity. PDA® technology was used to determine which of the alternate sequences with reduced or eliminated immunogenicity are compatible with maintaining the structure and function of the protein.

Using the above approach, the following positions in the 9-17 epitope were found to make the greatest overall contribution to binding propensity scores: L9, R10, and K14. The biding score for many different alleles, and hence immunogenicity, can be decreased by incorporating mutations including, but not limited to, the following: L9A, L9C, L9D, L9E, L9G, L9H, L9K, L9N, L9P, L9Q, L9R, L9S, L9T, R10A, R10C, R10D, R10E, R10F, R10G, R10H, R101, R10K, R10L, R10M, R10N, R10P, R10Q, R10S, R10T, R10W, R10Y, K14A, K14D, K14E, and K14Q. Point mutations that are especially effective in reducing immunogenicity include, but are not limited to, L9A, L9C, L9D, L9E, L9G, L9H, L9K, L9N, L9P, L9Q, L9R, L9S, L9T, R10A, R10C, R10D, and R10P. It is also possible to identify sequences that contain two or more mutations that each contributes to immunogenicity reduction.

Alternate sequences with decreased immunogenicity include, but are not limited to, those shown below. The number of hits for the 9-17 9mer at 1%, 3%, and 5% thresholds is shown. The number of hits for all overlapping 9mers (that is, 1-9, 2-10, 3-11, 4-12, 5-13, 6-14, 7-15, 8-16, 10-18, 11-19, 12-20, 13-21, 14-22, 15-23, 16-24, and 17-25) at 1%, 3%, and 5% thresholds is also shown. The wild-type sequence and matrix scores are shown in the top row of data for reference.

TABLE 4

Alternate less immunogenic
sequences, residues 9-17

| sequence | anchor1% | anchor3% | anchor5% | overlap1% | overlap3% | overlap5% |
|---|---|---|---|---|---|---|
| LRVLSKLLR | 17 | 31 | 36 | 18 | 33 | 45 |
| SRVLSKLLR | 0 | 0 | 0 | 18 | 33 | 45 |
| KRVLSKLLR | 0 | 0 | 0 | 18 | 33 | 45 |
| RRVLSKLLR | 0 | 0 | 0 | 18 | 33 | 45 |
| ERVLSKLLR | 0 | 0 | 0 | 18 | 33 | 45 |
| LDVLSKLLR | 0 | 0 | 0 | 18 | 33 | 45 |
| LEVLSKLLR | 0 | 6 | 9 | 18 | 33 | 45 |
| LSVLSKLLR | 0 | 5 | 6 | 18 | 33 | 45 |
| LTVLSKLLR | 0 | 5 | 9 | 18 | 33 | 45 |
| LRVLSELLR | 0 | 4 | 7 | 9 | 19 | 28 |
| LRVLSDLLR | 0 | 2 | 4 | 9 | 25 | 35 |
| LDVLSDLLR | 0 | 0 | 0 | 9 | 25 | 35 |
| LDVLSELLR | 0 | 0 | 0 | 9 | 19 | 28 |
| LDVLSRLLR | 0 | 0 | 0 | 10 | 31 | 45 |
| LEVLSDLLR | 0 | 0 | 0 | 9 | 25 | 35 |
| LEVLSELLR | 0 | 0 | 0 | 9 | 19 | 28 |
| LEVLSRLLR | 0 | 5 | 6 | 10 | 31 | 45 |
| LSVLSDLLR | 0 | 0 | 0 | 9 | 25 | 35 |
| LSVLSELLR | 0 | 0 | 0 | 9 | 19 | 28 |
| LSVLSRLLR | 0 | 2 | 5 | 10 | 31 | 45 |
| LTVLSDLLR | 0 | 0 | 0 | 9 | 25 | 35 |
| LTVLSELLR | 0 | 0 | 0 | 9 | 19 | 28 |
| LTVLSRLLR | 0 | 5 | 6 | 10 | 31 | 45 |

Using the above approach, the following positions in the 134-142 epitope make the greatest overall contribution to binding propensity scores: R135, K137, and R139. The binding score for many different alleles, and hence immunogenicity, can be decreased by incorporating mutations including, but not limited to, the following: R135A, R135C, R135D, R135E, R135F, R135G, R135H, R1351, R135K, R135L, R135M, R135N, R135P, R135Q, R135S, R135T, R135W, R135Y, K137A, K137P, R139A, R139D, R139E, and R139Q. It is also possible to identify sequences that contain two or more mutations that each contributes to immunogenicity reduction.

Alternate sequences with decreased immunogenicity include, but are not limited to, those shown below. The number of hits for the 135-143 9mer at 1%, 3%, and 5% thresholds is shown. The number of hits for all overlapping 9mers (that is, 127-135, 128-136, 129-137, 130-138, 131-139, 132-140, 133-141, 134-142, 136-144, 137-145, 138-146, 139-147, 140-148, 141-149, 142-150, and 143-151) at 1%, 3%, and 5% thresholds is also shown. The wild-type sequence and immunogenicity filter scores are shown in the top row of data for reference.

TABLE 5

alternate less immunogenic
variants, residues 135-143

| sequence | anchor1% | anchor3% | anchor5% | overlap1% | overlap3% | overlap5% |
|---|---|---|---|---|---|---|
| LRGKVRFLM | 17 | 18 | 21 | 0 | 15 | 46 |
| LDGKVRFLM | 0 | 0 | 0 | 0 | 11 | 35 |
| LEGKVRFLM | 0 | 3 | 11 | 1 | 11 | 36 |
| LQGKVRFLM | 7 | 17 | 17 | 2 | 15 | 47 |
| LKGKVRFLM | 6 | 16 | 17 | 1 | 14 | 46 |
| LRGKVDFLM | 0 | 0 | 0 | 0 | 10 | 24 |
| LRGKVEFLM | 0 | 3 | 4 | 0 | 10 | 28 |
| LRGNVDFLM | 0 | 0 | 0 | 0 | 10 | 24 |
| LRGQVDFLM | 0 | 0 | 0 | 0 | 10 | 24 |
| LRGSVDFLM | 0 | 0 | 0 | 0 | 10 | 24 |
| LRGTVDFLM | 0 | 0 | 0 | 0 | 10 | 24 |
| LRGRVDFLM | 0 | 0 | 1 | 0 | 10 | 24 |
| LRGNVEFLM | 0 | 0 | 0 | 0 | 10 | 28 |
| LRGSVEFLM | 0 | 0 | 0 | 0 | 10 | 28 |
| LRGRVEFLM | 0 | 0 | 1 | 0 | 10 | 28 |
| LRGQVEFLM | 0 | 0 | 3 | 0 | 10 | 28 |
| LRGTVEFLM | 0 | 0 | 0 | 0 | 10 | 28 |

Ensuring Compatibility with Structure and Function

Alternate methods may also be used to identify less immunogenic sequences. Here, positions P1-P4, P6, P7, and P9 in each MHC binding epitope were analyzed to identify a subset of amino acid substitutions that are potentially compatible with maintaining the structure and function of the protein. The subset of amino acids was initially selected by visual inspection and analysis of prior mutagenesis data, discussed above.

All possible combinations of selected amino acids were then analyzed using matrix method calculations, and sequences with significantly decreased immunogenicity were identified.

Sequences that reduce or eliminate the predicted MHC binding of residues 9-17 and do not vary the functionally important residue R10 include, but are not limited to, those shown below. These sequences eliminate all hits in the 9-17 epitope and also eliminate all or nearly all of the hits in the overlapping epitopes. The wild-type sequence and matrix method scores are shown in the top row of data for reference. In all of the variants shown below, it is possible to replace A9 with alternate non-hydrophobic residues, including D, E, G, H, K, N, Q, R, S, and T.

TABLE 6

Variants in residues 9-17, retaining R10

| sequence | anchor1% | anchor3% | anchor5% | overlap1% | overlap3% | overlap5% |
|---|---|---|---|---|---|---|
| LRVLSKLLR | 17 | 31 | 36 | 18 | 33 | 45 |
| ARALSKLLE | 0 | 0 | 0 | 0 | 0 | 0 |
| ARALSKALE | 0 | 0 | 0 | 0 | 0 | 0 |
| ARALSKALS | 0 | 0 | 0 | 0 | 0 | 0 |
| ARALSKALA | 0 | 0 | 0 | 0 | 0 | 0 |
| ARALSKILE | 0 | 0 | 0 | 0 | 0 | 0 |
| ARALSKVLE | 0 | 0 | 0 | 0 | 0 | 0 |
| ARALSRLLE | 0 | 0 | 0 | 0 | 0 | 0 |
| ARALSRALE | 0 | 0 | 0 | 0 | 0 | 0 |
| ARALSRALS | 0 | 0 | 0 | 0 | 0 | 0 |
| ARALSRALA | 0 | 0 | 0 | 0 | 0 | 0 |
| ARALSRILE | 0 | 0 | 0 | 0 | 0 | 0 |
| ARALSRVLE | 0 | 0 | 0 | 0 | 0 | 0 |
| ARVLSKLLE | 0 | 0 | 0 | 0 | 0 | 1 |
| ARVLSKALE | 0 | 0 | 0 | 0 | 0 | 1 |
| ARVLSKILE | 0 | 0 | 0 | 0 | 0 | 1 |
| ARVLSKVLE | 0 | 0 | 0 | 0 | 0 | 1 |
| ARVLSRLLE | 0 | 0 | 0 | 0 | 0 | 1 |
| ARVLSRALE | 0 | 0 | 0 | 0 | 0 | 1 |
| ARVLSRILE | 0 | 0 | 0 | 0 | 0 | 1 |
| ARVLSRVLE | 0 | 0 | 0 | 0 | 0 | 1 |
| ARILSKLLE | 0 | 0 | 0 | 0 | 0 | 1 |
| ARILSKALE | 0 | 0 | 0 | 0 | 0 | 1 |
| ARILSKILE | 0 | 0 | 0 | 0 | 0 | 1 |
| ARILSKVLE | 0 | 0 | 0 | 0 | 0 | 1 |
| ARILSRLLE | 0 | 0 | 0 | 0 | 0 | 1 |
| ARILSRALE | 0 | 0 | 0 | 0 | 0 | 1 |
| ARILSRILE | 0 | 0 | 0 | 0 | 0 | 1 |
| ARILSRVLE | 0 | 0 | 0 | 0 | 0 | 1 |

It is also possible to identify sequences with reduced immunogenicity that do not include mutations at the anchor position, L9, or which include an alternate hydrophobic residue at position 9. The wild-type sequence and matrix method scores are shown in the top row of data for reference.

TABLE 7

Variants in residues 9-17,
hydrophobic residue at 9

| sequence | anchor1% | anchor3% | anchor5% | overlap1% | overlap3% | overlap5% |
|---|---|---|---|---|---|---|
| LRVLSKLLR | 17 | 31 | 36 | 18 | 33 | 45 |
| LRALSRVLE | 1 | 4 | 8 | 0 | 0 | 0 |
| IRALSRVLE | 1 | 4 | 8 | 0 | 0 | 0 |
| VRALSRVLE | 1 | 4 | 8 | 0 | 0 | 0 |
| LRALSKVLE | 2 | 7 | 9 | 0 | 0 | 0 |
| IRALSKVLE | 2 | 7 | 9 | 0 | 0 | 0 |
| VRALSKVLE | 2 | 7 | 9 | 0 | 0 | 0 |
| LRALSRALE | 4 | 6 | 14 | 0 | 0 | 0 |
| IRALSRALE | 4 | 6 | 14 | 0 | 0 | 0 |
| VRALSRALE | 4 | 6 | 14 | 0 | 0 | 0 |

Less immunogenic sequences were also identified for the residue 69-77 epitope. These sequences eliminate all hits in the 69-77 epitope and also eliminate nearly all of the hits in the overlapping epitopes. The wild-type sequence and matrix method scores are shown in the top row of data for reference.

TABLE 8

Less immunogenic variants, residues 69-77

| sequence | anchor1% | anchor3% | anchor5% | overlap1% | overlap3% | overlap5% |
|---|---|---|---|---|---|---|
| LLLEGVMAA | 2 | 8 | 14 | 0 | 3 | 10 |
| ALLEGVMAA | 0 | 0 | 0 | 0 | 0 | 1 |
| ALLEGVKAA | 0 | 0 | 0 | 0 | 0 | 1 |
| ALLEGVLAA | 0 | 0 | 0 | 0 | 0 | 1 |
| ALLEGVQAA | 0 | 0 | 0 | 0 | 0 | 1 |
| ALLEGAMAA | 0 | 0 | 0 | 0 | 0 | 1 |
| ALLEGAKAA | 0 | 0 | 0 | 0 | 0 | 1 |
| ALLEGALAA | 0 | 0 | 0 | 0 | 0 | 1 |
| ALLEGAQAA | 0 | 0 | 0 | 0 | 0 | 1 |
| ALLEGLMAA | 0 | 0 | 0 | 0 | 0 | 1 |
| ALLEGLKAA | 0 | 0 | 0 | 0 | 0 | 1 |
| ALLEGLLAA | 0 | 0 | 0 | 0 | 0 | 1 |
| ALLEGLQAA | 0 | 0 | 0 | 0 | 0 | 1 |
| QLLEGVMAA | 0 | 0 | 0 | 0 | 1 | 1 |
| QLLEGVKAA | 0 | 0 | 0 | 0 | 1 | 1 |
| QLLEGVLAA | 0 | 0 | 0 | 0 | 1 | 1 |
| QLLEGVQAA | 0 | 0 | 0 | 0 | 1 | 1 |
| QLLEGAMAA | 0 | 0 | 0 | 0 | 1 | 1 |
| QLLEGAKAA | 0 | 0 | 0 | 0 | 1 | 1 |
| QLLEGALAA | 0 | 0 | 0 | 0 | 1 | 1 |
| QLLEGAQAA | 0 | 0 | 0 | 0 | 1 | 1 |
| QLLEGLMAA | 0 | 0 | 0 | 0 | 1 | 1 |
| QLLEGLKAA | 0 | 0 | 0 | 0 | 1 | 1 |
| QLLEGLLAA | 0 | 0 | 0 | 0 | 1 | 1 |
| QLLEGLQAA | 0 | 0 | 0 | 0 | 1 | 1 |
| QLLKGVMAA | 0 | 0 | 0 | 0 | 1 | 1 |
| QLLKGVKAA | 0 | 0 | 0 | 0 | 1 | 1 |
| QLLKGVLAA | 0 | 0 | 0 | 0 | 1 | 1 |
| QLLKGAMAA | 0 | 0 | 0 | 0 | 1 | 1 |
| QLLKGAKAA | 0 | 0 | 0 | 0 | 1 | 1 |
| QLLKGALAA | 0 | 0 | 0 | 0 | 1 | 1 |

Less immunogenic sequences were also identified for the residue 97-105 epitope. These sequences eliminate all hits in the 97-105 epitope and also eliminate nearly all of the hits in the overlapping epitopes. The wild-type sequence and matrix method scores are shown in the top row of data for reference.

TABLE 9
Less immunogenic variants, residues 97-105

| | | | | | | |
|---|---|---|---|---|---|---|
| sequence | anchor1% | anchor3% | anchor5% | overlap1% | overlap3% | overlap5% |

| | | | | | | |
|---|---|---|---|---|---|---|
| VRLLLGALQ | 6 | 25 | 32 | 1 | 2 | 3 |
| VKLILGALE | 0 | 0 | 0 | 0 | 0 | 2 |
| VKVLLGALE | 0 | 0 | 0 | 0 | 0 | 2 |
| VKVLLGSLE | 0 | 0 | 0 | 0 | 0 | 2 |
| VKVILGALE | 0 | 0 | 0 | 0 | 0 | 2 |
| VKVILGSLE | 0 | 0 | 0 | 0 | 0 | 2 |
| VQVLLGALE | 0 | 0 | 0 | 0 | 0 | 2 |
| VQVLLGSLE | 0 | 0 | 0 | 0 | 0 | 2 |
| VQVILGALE | 0 | 0 | 0 | 0 | 0 | 2 |
| IKLILGALE | 0 | 0 | 0 | 0 | 0 | 2 |
| IKVLLGALE | 0 | 0 | 0 | 0 | 0 | 2 |
| IKVLLGSLE | 0 | 0 | 0 | 0 | 0 | 2 |
| IKVTLGALE | 0 | 0 | 0 | 0 | 0 | 2 |
| IKVILGSLE | 0 | 0 | 0 | 0 | 0 | 2 |
| IQVLLGALE | 0 | 0 | 0 | 0 | 0 | 2 |
| IQVLLGSLE | 0 | 0 | 0 | 0 | 0 | 2 |
| IQVILGALE | 0 | 0 | 0 | 0 | 0 | 2 |
| TRLLLGALE | 0 | 0 | 0 | 0 | 0 | 2 |
| TRLLLGSLE | 0 | 0 | 0 | 0 | 0 | 2 |
| TRLILGALE | 0 | 0 | 0 | 0 | 0 | 2 |
| TRLILGSLE | 0 | 0 | 0 | 0 | 0 | 2 |
| TRILLGALE | 0 | 0 | 0 | 0 | 0 | 2 |
| TRILLGSLE | 0 | 0 | 0 | 0 | 0 | 2 |
| TRIILGALE | 0 | 0 | 0 | 0 | 0 | 2 |
| TRIILGSLE | 0 | 0 | 0 | 0 | 0 | 2 |
| TRVLLGALE | 0 | 0 | 0 | 0 | 0 | 2 |
| TRVLLGSLE | 0 | 0 | 0 | 0 | 0 | 2 |
| TRVILGALE | 0 | 0 | 0 | 0 | 0 | 2 |
| TRVILGSLE | 0 | 0 | 0 | 0 | 0 | 2 |
| TKLLLGALE | 0 | 0 | 0 | 0 | 0 | 2 |
| TKLLLGSLE | 0 | 0 | 0 | 0 | 0 | 2 |
| TKLILGALE | 0 | 0 | 0 | 0 | 0 | 2 |
| TKLILGSLE | 0 | 0 | 0 | 0 | 0 | 2 |
| TKILLGALE | 0 | 0 | 0 | 0 | 0 | 2 |
| TKILLGSLE | 0 | 0 | 0 | 0 | 0 | 2 |
| TKIILGALE | 0 | 0 | 0 | 0 | 0 | 2 |
| TKIILGSLE | 0 | 0 | 0 | 0 | 0 | 2 |
| TKVLLGALE | 0 | 0 | 0 | 0 | 0 | 2 |
| TKVLLGSLE | 0 | 0 | 0 | 0 | 0 | 2 |
| TKVILGALE | 0 | 0 | 0 | 0 | 0 | 2 |
| TKVILGSLE | 0 | 0 | 0 | 0 | 0 | 2 |
| TQLLLGALE | 0 | 0 | 0 | 0 | 0 | 2 |
| TQLLLGSLE | 0 | 0 | 0 | 0 | 0 | 2 |
| TQLILGALE | 0 | 0 | 0 | 0 | 0 | 2 |
| TQLILGSLE | 0 | 0 | 0 | 0 | 0 | 2 |
| TQILLGALE | 0 | 0 | 0 | 0 | 0 | 2 |
| TQILLGSLE | 0 | 0 | 0 | 0 | 0 | 2 |
| TQIILGALE | 0 | 0 | 0 | 0 | 0 | 2 |
| TQIILGSLE | 0 | 0 | 0 | 0 | 0 | 2 |
| TQVLLGALE | 0 | 0 | 0 | 0 | 0 | 2 |
| TQVLLGSLE | 0 | 0 | 0 | 0 | 0 | 2 |
| TQVILGALE | 0 | 0 | 0 | 0 | 0 | 2 |
| TQVILGSLE | 0 | 0 | 0 | 0 | 0 | 2 |

Finally, less immunogenic sequences were identified for the residue 135-143 epitope. These sequences conserve the identity of several residues that have been implicated in TPO function: R136, K138, and R140. The wild-type sequence and matrix method scores are shown in the top row of data for reference. These sequences eliminate all hits in the 135-143 epitope and also eliminate many of the hits in the overlapping epitopes. The wild-type sequence and matrix scores are shown in the top row of data for reference.

TABLE 10

Less immunogenic variants, residues 135-143,
retaining R136, K138, and R140

| sequence | anchor1% | anchor3% | anchor5% | overlap1% | overlap3% | overlap5% |
|---|---|---|---|---|---|---|
| LRGKVRFLM | 17 | 18 | 21 | 0 | 15 | 46 |
| ARGKVKHLL | 0 | 0 | 0 | 0 | 7 | 16 |
| ARGKVKLLL | 0 | 0 | 0 | 0 | 7 | 17 |
| ARGKVKHLM | 0 | 0 | 0 | 0 | 7 | 18 |
| ARGKVKLLM | 0 | 0 | 0 | 0 | 7 | 19 |
| ARGKVRHLL | 0 | 0 | 0 | 0 | 7 | 20 |
| ARGKVKFLQ | 0 | 0 | 0 | 0 | 7 | 20 |
| ARGKVKHLQ | 0 | 0 | 0 | 0 | 7 | 20 |
| ARGKVKLLQ | 0 | 0 | 0 | 0 | 7 | 20 |
| ARGKVKYLQ | 0 | 0 | 0 | 0 | 7 | 20 |
| ARGKVRHLM | 0 | 0 | 0 | 0 | 7 | 22 |
| ARGKVRHLQ | 0 | 0 | 0 | 0 | 7 | 24 |
| ARGKVKFLL | 0 | 0 | 0 | 0 | 8 | 17 |
| ARGKVKYLL | 0 | 0 | 0 | 0 | 8 | 17 |
| ARGKVKFLM | 0 | 0 | 0 | 0 | 8 | 22 |
| ARGKVKYLM | 0 | 0 | 0 | 0 | 8 | 22 |
| ARGKVRFLQ | 0 | 0 | 0 | 0 | 12 | 41 |
| ARGKVRYLQ | 0 | 0 | 0 | 0 | 12 | 41 |
| ARGKVRFLL | 0 | 0 | 0 | 0 | 13 | 38 |
| ARGKVRYLL | 0 | 0 | 0 | 0. | 13 | 38 |
| ARGKVRFLM | 0 | 0 | 0 | 0 | 13 | 43 |
| ARGKVRYLM | 0 | 0 | 0 | 0 | 13 | 43 |

It is also possible to identify sequences with reduced immunogenicity that maintain the hydrophobicity of the anchor position, L135. The wild-type sequence and matrix scores are shown in the top row of data for reference.

TABLE 11

Less immunogenic variants, residues 135-143,
retaining hydrophobic residue at 135

| sequence | anchor1% | anchor3% | anchor5% | overlap1% | overlap3% | overlap5% |
|---|---|---|---|---|---|---|
| LRGKVRFLM | 17 | 18 | 21 | 0 | 15 | 46 |
| LRGKVKYLL | 2 | 17 | 17 | 0 | 10 | 19 |
| IRGKVKYLL | 2 | 17 | 17 | 0 | 10 | 19 |
| VRGKVKYLL | 2 | 17 | 17 | 0 | 12 | 22 |
| FRGKVRYLL | 6 | 10 | 13 | 0 | 13 | 39 |
| FRGKVRHLL | 8 | 11 | 18 | 0 | 7 | 21 |
| LRGKVKHLL | 10 | 17 | 17 | 0 | 9 | 18 |
| IRGKVKHLL | 10 | 17 | 17 | 0 | 9 | 18 |
| VRGKVKHLL | 10 | 17 | 17 | 0 | 11 | 21 |
| LRGKVKFLL | 14 | 17 | 17 | 0 | 10 | 19 |
| IRGKVKFLL | 14 | 17 | 17 | 0 | 10 | 19 |
| VRGKVKFLL | 14 | 17 | 17 | 0 | 12 | 22 |
| LRGKVRFLN | 3 | 17 | 17 | 0 | 14 | 39 |
| LRGKVRDLM | 0 | 6 | 14 | 0 | 9 | 21 |
| LRGKVRDLN | 0 | 1 | 3 | 0 | 9 | 18 |
| LRGKVRDLL | 0 | 0 | 3 | 0 | 9 | 19 |
| LRGKVRTLM | 4 | 13 | 18 | 0 | 9 | 24 |
| LRGKVRTLN | 0 | 4 | 5 | 0 | 9 | 21 |
| LRGKVRTLL | 1 | 1 | 10 | 0 | 9 | 22 |
| LRGKVRQLM | 10 | 17 | 18 | 0 | 9 | 24 |
| LRGKVRQLN | 3 | 6 | 13 | 0 | 9 | 21 |
| LRGKVRQLL | 1 | 12 | 15 | 0 | 9 | 22 |
| LRDKVRDLM | 0 | 0 | 0 | 0 | 12 | 22 |
| LRDKVRDLN | 0 | 0 | 0 | 0 | 12 | 19 |
| LRDKVRDLL | 0 | 0 | 0 | 0 | 12 | 20 |
| LRDKVRTLM | 0 | 1 | 1 | 0 | 12 | 25 |
| LRDKVRTLN | 0 | 0 | 0 | 0 | 12 | 22 |
| LRDKVRTLL | 0 | 0 | 1 | 0 | 12 | 23 |
| LRDKVRQLM | 0 | 1 | 7 | 0 | 12 | 25 |
| LRDKVRQLN | 0 | 1 | 2 | 0 | 12 | 22 |
| LRDKVRQLL | 0 | 0 | 0 | 0 | 12 | 23 |

Additional sequences with reduced immunogenicity were identified that conserve L135 and retain positively charged residues at positions 136, 138, and 140.

TABLE 12

Less immunogenic variants, residues 135-143
retaining L135, positive charge at 136, 138, and 140

| sequence | anchor1% | anchor3% | anchor5% | overlap1% | overlap3% | overlap5% |
|---|---|---|---|---|---|---|
| LRGKVRFLM | 17 | 18 | 21 | 0 | 15 | 46 |
| LKGKVRKLL | 0 | 2 | 4 | 1 | 7 | 17 |
| LKGKVRQLL | 0 | 0 | 2 | 1 | 7 | 17 |
| LKGKVRYLL | 0 | 0 | 2 | 1 | 9 | 21 |
| LKGKVKQLL | 0 | 1 | 4 | 1 | 7 | 16 |
| LKAKVRKLL | 0 | 1 | 3 | 1 | 13 | 31 |
| LKAKVRQLL | 0 | 0 | 1 | 1 | 13 | 31 |
| LKAKVRYLL | 0 | 0 | 2 | 1 | 15 | 35 |
| LKAKVKQLL | 0 | 0 | 3 | 1 | 13 | 22 |
| LKAKVKYLL | 0 | 1 | 4 | 1 | 13 | 23 |

To obtain a greater reduction in predicted immunogenicity, mutations in residues 135-143 were combined with mutations in residues 127-134 and/or residues 144-151. The wild-type sequence and matrix method scores are shown in the top row of data for each reference.

TABLE 13
Less immunogenic variants, residues 127-151

| sequence | anchor1% | anchor3% | anchor5% | overlap1% | overlap3% | overlap5% |
|---|---|---|---|---|---|---|
| LSFQHLLRGKVRFLMLV | 17 | 18 | 21 | 0 | 23 | 57 |
| ESFEHLLKGKVRQLLEA | 0 | 0 | 2 | 0 | 0 | 1 |
| ESFEHLLKGKVRYLLEA | 0 | 0 | 2 | 0 | 0 | 1 |
| ESFEHLARGKVRYLMEA | 0 | 0 | 0 | 0 | 0 | 1 |
| ESFEHLARGKVKFLMEA | 0 | 0 | 0 | 0 | 0 | 1 |

### Example 3

### Homology Modeling of TPO

A model of the three-dimensional structure of TPO was generated using the Homology module in the computer program InsightII. The crystal structure of erythropoietin (PDB code 1EER, Syed et. al. Nature 395:511 (1998)) and the sequence of TPO as known in the art were used to produce the homology model. As TPO and EPO share limited sequence similarity, the correct alignment between the two sequences is somewhat ambiguous. A number of possible alignments were tested, and the sequence alignment shown in FIG. 2 was observed to produce the highest quality models.

### Example 4

### Identification of Structured, Less Immunogenic TPO Variants

PDA® calculations were performed to predict the energies of each of the less immunogenic variants of the major epitopes in TPO, as well as the native sequence. The energies of the native sequences were then compared with the energies of the variants to determine which of the less immunogenic TPO sequences are compatible with maintaining the structure and function of TPO. Each calculation used one or more of the homology models produced above as the template. Unless otherwise noted, the nine residues comprising an epitope of interest were determined to be the variable residue positions. A variety of rotameric states were considered for each variable position, and the sequence was constrained to be the sequence of a specific less immunogenic variant identified previously. Rotamer-template and rotamer-rotamer energies were then calculated using a force field including terms describing van der Waals interactions, hydrogen bonds, electrostatics, and solvation. The optimal rotameric configurations for each sequence were determined using DEE as a combinatorial optimization method.

In general, all of the sequences whose energies are similar to or better than (lower energies are more favorable) the energy of the native sequence are likely to be structured. Sequences that conserve those residues that are known to be important for function are likely to also be active. Alternatively, it is possible to model the interaction of TPO with mpl receptor and then to determine which variant sequences are compatible with forming this interaction.

Shown below is the calculated immunogenicity and energy of the native sequence and several less immunogenic variants of epitope 1 (residues 9-17). Energies were calculated using two different homology models; although the exact values vary the overall trends are consistent.

TABLE 14

Stable, less immunogenic
variants, Residues 9-17

| | | | | | | | | |
|---|---|---|---|---|---|---|---|---|
| sequence | a1% | a3% | A5% | o1% | o3% | o5% | 5 2 | 8 2 |

| | | | | | | | | |
|---|---|---|---|---|---|---|---|---|
| LRVLSKLLR | 17 | 31 | 36 | 18 | 33 | 45 | 22.25 | 212.08 |
| KRVLSKLLK | 0 | 0 | 0 | 0 | 15 | 25 | 17.32 | 209.67 |
| KRVLSKLLQ | 0 | 0 | 0 | 0 | 11 | 21 | 16.86 | 206.04 |
| ARALSKALE | 0 | 0 | 0 | 0 | 0 | 0 | −12.16 | −7.53 |
| ARALSKALS | 0 | 0 | 0 | 0 | 0 | 0 | −10.62 | −7.28 |
| ARALSKVLE | 0 | 0 | 0 | 0 | 0 | 0 | −13.19 | −1.84 |
| ARALSRALS | 0 | 0 | 0 | 0 | 0 | 0 | −12.77 | −8.02 |
| ARALSRVLE | 0 | 0 | 0 | 0 | 0 | 0 | −14.98 | −3.03 |
| ARILSKALE | 0 | 0 | 0 | 0 | 0 | 1 | −13.81 | −8.47 |
| ARILSKVLE | 0 | 0 | 0 | 0 | 0 | 1 | −14.48 | −2.95 |
| ARILSRALE | 0 | 0 | 0 | 0 | 0 | 1 | −15.08 | −10.52 |
| ARILSRLLE | 0 | 0 | 0 | 0 | 0 | 1 | 20.09 | 211.32 |
| ARILSRVLE | 0 | 0 | 0 | 0 | 0 | 1 | −15.75 | −5.02 |
| ARVLSKALE | 0 | 0 | 0 | 0 | 0 | 1 | −14.41 | −8.87 |
| ARVLSKLLE | 0 | 0 | 0 | 0 | 0 | 1 | 20.82 | 212.96 |
| ARVLSKVLE | 0 | 0 | 0 | 0 | 0 | 1 | −15.11 | −3.38 |
| ARVLSRALE | 0 | 0 | 0 | 0 | 0 | 1 | −15.68 | −11.34 |
| ARVLSRVLE | 0 | 0 | 0 | 0 | 0 | 1 | −16.38 | −5.85 |

Shown below is the calculated immunogenicity and energy of the native sequence and several less immunogenic variants of epitope 2 (residues 135-143). Energies were calculated using two different homology models; although the exact values vary the overall trends are consistent. In calculations for the last group of variants, residues 129, 132, and 135-145 were all treated as variable positions.

TABLE 15

Stable, less immunogenic
variants, residues 127-151

| | | | | | | | | |
|---|---|---|---|---|---|---|---|---|
| | | | | | | | 5_2 | 8_1 |
| Sequence | a1% | a3% | a5% | o1% | o3% | o5% | energy | energy |

| | | | | | | | | |
|---|---|---|---|---|---|---|---|---|
| LSFQHLLRGKVRFLMLV | 17 | 18 | 21 | 0 | 15 | 46 | −84.72 | −88.95 |
| LKGKVRYLL | 0 | 0 | 2 | 1 | 14 | 41 | −83.52 | −87.19 |
| LKGKVRQLL | 0 | 0 | 2 | 1 | 8 | 22 | −81.62 | −85.05 |
| LKGKLRYLL | 0 | 0 | 2 | 0 | 14 | 41 | −85.41 | −79.90 |
| LKGKLRQLL | 0 | 0 | 2 | 0 | 8 | 22 | −83.66 | −77.51 |
| ARGKVRYLM | 0 | 0 | 0 | 0 | 13 | 43 | −75.61 | −79.56 |
| ARGKVKFLM | 0 | 0 | 0 | 0 | 8 | 22 | −80.59 | −81.54 |
| ARGKVKFLL | 0 | 0 | 0 | 0 | 8 | 17 | −79.54 | −79.06 |
| ARGKVKHLM | 0 | 0 | 0 | 0 | 7 | 18 | −76.79 | −79.55 |
| ARGKVKLLM | 0 | 0 | 0 | 0 | 7 | 19 | −83.70 | −82.41 |
| ARGKVKLLL | 0 | 0 | 0 | 0 | 7 | 17 | −82.65 | −79.94 |
| ARGKVKYLM | 0 | 0 | 0 | 0 | 8 | 22 | −83.26 | −83.42 |
| ARGKVKYLL | 0 | 0 | 0 | 0 | 8 | 17 | −82.21 | −80.94 |
| LSFQHLLRGKVRFLMLV | 17 | 18 | 21 | 0 | 23 | 57 | −89.13 | 37.40 |
| ESFEHLLRGKVRFLMLV | 17 | 18 | 21 | 0 | 15 | 44 | −103.33 | −45.78 |
| LSFQHLLRGKVRFLMEA | 17 | 18 | 21 | 0 | 8 | 15 | −90.88 | 38.74 |
| ESFEHLLKGKVRQLLEA | 0 | 0 | 2 | 0 | 0 | 1 | −102.01 | −40.98 |
| ESFEHLLKGKVRYLLEA | 0 | 0 | 2 | 0 | 0 | 1 | −104.90 | −42.21 |
| ESFEHLARGKVRYLMEA | 0 | 0 | 0 | 0 | 0 | 1 | −95.81 | −35.14 |
| ESFEHLARGKVKFLMEA | 0 | 0 | 0 | 0 | 0 | 1 | −94.75 | −35.21 |

Shown below is the calculated immunogenicity and energy of the native sequence and several less immunogenic variants of epitope 3 (residues 69-77). Energies were calculated using two different homology models; although the exact values vary the overall trends are consistent.

TABLE 16

Stable, less immunogenic
variants, residues 69-77

| | | | | | | | | |
|---|---|---|---|---|---|---|---|---|
| | | | | | | | 5_2 | 8_1 |
| sequence | a1% | a3% | A5% | o1% | o3% | o5% | energy | energy |

| | | | | | | | | |
|---|---|---|---|---|---|---|---|---|
| LLLEGVMAA | 2 | 8 | 14 | 0 | 3 | 10 | −56.87 | −59.30 |
| LLLEGLMAA | 0 | 0 | 2 | 0 | 3 | 10 | −52.91 | −61.31 |
| LLLEGVKAA | 0 | 2 | 3 | 0 | 3 | 10 | −55.73 | −61.60 |
| LLLEGVQAA | 0 | 2 | 3 | 0 | 3 | 10 | −57.02 | −61.18 |
| LLLEGAMAA | 0 | 2 | 4 | 0 | 3 | 10 | −49.09 | −51.72 |
| ALLEGVLAA | 0 | 0 | 0 | 0 | 0 | 1 | −55.66 | −52.58 |
| ALLEGVQAA | 0 | 0 | 0 | 0 | 0 | 1 | −54.73 | −54.20 |
| ALLEGVMAA | 0 | 0 | 0 | 0 | 0 | 1 | −54.58 | −52.54 |
| QLLEGVQAA | 0 | 0 | 0 | 0 | 1 | 1 | −54.41 | −56.74 |
| QLLEGVMAA | 0 | 0 | 0 | 0 | 1 | 1 | −54.27 | −54.95 |
| ALLEGVKAA | 0 | 0 | 0 | 0 | 0 | 1 | −53.44 | −54.77 |
| QLLEGVKAA | 0 | 0 | 0 | 0 | 1 | 1 | −53.07 | −57.17 |
| QLLKGVLAA | 0 | 0 | 0 | 0 | 1 | 1 | −52.61 | −55.71 |
| QLLKGVMAA | 0 | 0 | 0 | 0 | 1 | 1 | −52.00 | −55.55 |
| ALLEGLLAA | 0 | 0 | 0 | 0 | 0 | 1 | −51.78 | −54.66 |
| ALLEGLQAA | 0 | 0 | 0 | 0 | 0 | 1 | −50.74 | −56.24 |
| QLLKGVKAA | 0 | 0 | 0 | 0 | 1 | 1 | −50.73 | −56.14 |
| ALLEGLMAA | 0 | 0 | 0 | 0 | 0 | 1 | −50.62 | −54.56 |
| QLLEGLMAA | 0 | 0 | 0 | 0 | 1 | 1 | −50.31 | −56.96 |

Shown below is the calculated immunogenicity and energy of the native sequence and several less immunogenic variants of epitope 4 (residues 96-104). Energies were calculated using two different homology models; although the exact values vary the overall trends are consistent.

TABLE 17

Stable, less immunogenic
variants, residues 96-104

| | | | | | | | 5_2 | 8_1 |
|---|---|---|---|---|---|---|---|---|
| sequence | a1% | a3% | a5% | o1% | o3% | o5% | energy | energy |
| VRLLLGALQ | 6 | 25 | 32 | 1 | 2 | 5 | −71.58 | −63.96 |
| TKILLGSLE | 0 | 0 | 0 | 0 | 0 | 4 | −66.25 | −60.24 |
| TKLLLGSLE | 0 | 0 | 0 | 0 | 0 | 4 | −65.64 | −60.07 |
| TKVLLGSLE | 0 | 0 | 0 | 0 | 0 | 4 | −66.61 | −60.03 |
| TRILLGSLE | 0 | 0 | 0 | 0 | 0 | 4 | −66.10 | −63.39 |
| TRLLLGSLE | 0 | 0 | 0 | 0 | 0 | 4 | −66.10 | −64.57 |
| TRLLLGSLQ | 0 | 0 | 0 | 1 | 2 | 5 | −68.59 | −60.87 |
| TRVLLGSLE | 0 | 0 | 0 | 0 | 0 | 4 | −67.29 | −64.65 |
| VKLILGALE | 0 | 0 | 0 | 0 | 0 | 4 | −65.45 | −64.31 |
| VKLILGALQ | 0 | 1 | 4 | 1 | 2 | 5 | −67.91 | −60.62 |
| VKVILGALE | 0 | 0 | 0 | 0 | 0 | 4 | −65.48 | −63.87 |
| VKVILGSLE | 0 | 0 | 0 | 0 | 0 | 4 | −69.69 | −63.87 |
| VKVLLGALE | 0 | 0 | 0 | 0 | 0 | 4 | −69.17 | −62.15 |
| VKVLLGSLE | 0 | 0 | 0 | 0 | 0 | 4 | −73.35 | −66.03 |
| VQVLLGALE | 0 | 0 | 0 | 0 | 0 | 2 | −67.72 | −62.42 |
| VQVLLGALQ | 0 | 1 | 4 | 1 | 2 | 3 | −70.37 | −58.84 |
| VQVLLGSLE | 0 | 0 | 0 | 0 | 0 | 2 | −71.90 | −66.30 |

### Example 5

### Activity of Reduced-Immunogenicity TPO Variants

Activity of the variant TPO molecules was determined by assaying a TPO-sensitive cell line for proliferation. BaF3 cells were transfected with mpl, which is the TPO receptor, and luciferase. The cells were prepared in the presence of interleukin-3, starved overnight, exposed to a variant TPO protein or control protein for 24 hours, and monitored for proliferation using Promega Corporation's CellTiter-Glo™ Luminescent Cell Viability Assay, Technical Bulletin No. 288 (revised May 2001). This is a homogeneous method of determining the number of viable cells in culture based on quantitation of the ATP present, which signals the presence of metabolically active cells. Wild type thrombopoietin (wt TPO) contains amino acids 1 to 157. Variant TPO proteins were expressed in 293T cells and the culture supernatant was used to test activity. Commercial thrombopoietin was produced in E. coli and has 174 amino acid residues. EC₅₀ values are normalized relative to wild type.

The activity of variant TPO proteins with mutations in residues 9-17 and 135-143 are shown in the table below. The variants were selected to modify the residues that are predicted to contribute most to MHC-binding affinity.

TABLE 18
Activity of variant TPO proteins

| TPO variant | EC50 |
|---|---|
| wt TPO | 1.0000 |
| R136K | 0.7500 |
| K138T/R140E | 0.1605 |
| K138N/R140E | 0.2875 |
| R10E/K14E | 0.1468 |
| R10E/K14D | 0.2300 |
| R10T/K14D | 0.1302 |

The activity of variant TPO proteins with mutations in residues 9-17 are shown in the table below. These variants were selected to have reduced immunogenicity and retain functionally important residues.

TABLE 19
Activity of variant TPO proteins

| TPO Variant | EC50 |
|---|---|
| L9K/R17K | 0.0591 |
| L9K/R17Q | 1.5810 |
| L9A/V11A/L15A/R17E | 0.0002 |
| L9A/V11A/L15A/R17S | 0.0002 |
| L9A/V11A/K14R/L15A/R17S | 0.0001 |
| L9A/V11A/K14R/L15V/R17E | 0.0000 |
| L9A/V11I/L15A/R17E | 0.0006 |
| L9A/V11I/L15V/R17E | 0.0079 |
| L9A/V11I/K14R/R17E | 0.0507 |
| L9A/V11I/K14R/L15V/R17E | 0.0027 |
| L9A/L15A/R17E | 0.0008 |
| L9A/R17E | 0.0714 |
| L9A/L15V/R17E | 0.0018 |
| L9A/K14R/L15A/R17E | 0.0002 |
| L9A/K14R/L15V/R17E | 0.0009 |
| L9A | 1.0096 |
| V11A | 0.0856 |
| V11I | 0.0002 |
| K14R | 0.3390 |
| L15A | 0.0392 |
| L15V | 0.3048 |
| R17E | 0.0532 |
| R17K | 0.4767 |
| R17Q | 0.0242 |
| R17S | 0.0405 |
| wt TPO | 1.0000 |

The activity of variant TPO proteins with mutations in residues 129-145 are shown in the table below. These variants were selected to have reduced immunogenicity and retain functionally important residues.

TABLE 20
Activity of variant TPO proteins

| TPO Variant | EC50 |
|---|---|
| R136K/F141Q/M143L | 0.0364 |
| R136K/V139L/F141Y/M143L | 0.0249 |
| R136K/V139L/F141Q/M143L | 0.0087 |
| L135A/F141Y | 0.0024 |
| L135A/R140K | 0.0007 |
| L135A/R140K/M143L | 0.0002 |
| L135A/R140K/F141H | 0.0000 |
| L135A/R140K/F141L | 0.0000 |
| L135A/R140K/F141L/M143L | 0.0000 |
| L135A/R140K/F141Y | 0.0035 |
| L135A/R140K/F141Y/M143L | 0.0014 |
| L144E/V145A | 0.0709 |
| L129E/Q132E/R136K/F141Q/M143L/L144E/V145A | 0.0003 |
| L129E/Q132E/R136K/F141Y/M143L/L144E/V145A | 0.0626 |
| L129E/Q132E/L135A/F141Y/L144E/V145A | 0.0532 |
| L129E/Q132E/L135A/R140A/L144E/V145A | 0.0013 |
| Q132E | 0.3819 |
| L135A | 0.0055 |
| R136K | 1.1103 |
| V139L | 0.0599 |
| R140K | 0.0008 |
| F141H | 0.0538 |
| F141L | 0.0623 |
| F141Q | 0.0127 |
| F141Y | 0.0609 |
| M143L | 1.0479 |
| L144E | 0.6523 |
| WT TPO | 1.0000 |

The activity of variant TPO proteins with mutations in residues 69-77 are shown in the table below. These variants were selected to have reduced immunogenicity and retain functionally important residues.

TABLE 21
Activity of variant TPO proteins

| TPO Variant | EC50 |
|---|---|
| V74L | 0.0474 |
| M75K | 1.5463 |
| M75Q | 1.2431 |
| V74A | 0.0415 |
| L69A/M75L | 0.0662 |
| L69A/M75Q | <1.0 |
| L69A | 0.0612 |
| L69Q/M75Q | 0.5154 |
| L69Q | 0.5712 |
| L69A/M75K | 0.6385 |
| L69Q/M75K | 1.4058 |
| L69Q/E72K/M75L | 0.1975 |
| L69Q/E72K | 1.1719 |
| L69A/V74L/M75L | 0.0140 |
| L69Q/E72K/M75K | 0.4465 |
| L69A/V74L | 0.0394 |
| L69Q/V74L | 0.4117 |
| E72K | 0.0323 |
| M75L | 0.0604 |
| wt TPO | 1.0000 |

The activity of variant TPO proteins with mutations in residues 97-105 are shown in the table below. These variants were selected to have reduced immunogenicity and retain functionally important residues.

TABLE 22
Activity of variant TPO proteins

| TPO Variant | EC50 |
|---|---|
| V97T/R98K/L99I/A103S/Q105E | 0.0001 |
| V97T/R98K/A103S/Q105E | 0.0001 |
| V97T/R98K/L99V/A103S/Q105E | 0.0000 |
| V97T/L99I/A103S/Q105E | 0.0002 |
| V97T/A103S/Q105E | 0.0001 |
| V97T/A103S | 0.0189 |
| V97T/L99V/A103S/Q105E | 0.0031 |
| R98K/L100I/Q105E | 0.0056 |
| R98K/L100I | 0.0122 |
| R98K/L99V/L100I/Q105E | 0.0007 |
| R98K/L99V/L100I/A103S/Q105E | 0.0009 |
| R98K/L99V/Q105E | 0.0222 |
| R98K/L99V/A103S/Q105E | 0.0602 |
| R98Q/L99V/Q105E | 0.0568 |
| R98K/L99V | 0.0705 |
| R98Q/L99V/A103S/Q105E | 0.0508 |
| V97T | 0.0000 |
| R98K | 0.2348 |
| R98Q | 0.8431 |
| L99I | 0.2686 |
| L99V | 0.1210 |
| L100I | 0.0546 |
| A103S | 0.0519 |
| Q105E | 0.0633 |
| wt TPO | 1.0000 |

### Example 6

### Experimental Testing of TPO Immunogenicity

The TPO variants identified above are tested in accordance with Stickler, M M, Estell, D A, Harding, F A “CD4+ T-Cell Epitope Determination Using Unexposed Human Donor Peripheral Blood Mononuclear Cells” J. Immunotherapy, 23, 654-660 (2000), incorporated by reference.

### Example 7

### Identification of MHC-Binding Epitopes in CNTF

In order to find MHC-binding epitopes, each 9-residue fragment of native human CNTF was analyzed for its propensity to bind to each of 52 class II MHC alleles for which peptide binding affinity matrices have been derived. The calculations were performed using cutoffs of 1%, 3%, and 5%. The number of alleles that each peptide is predicted to bind at each of these cutoffs are shown below. 9-mer peptides that are not listed below are not predicted to bind to any alleles at the 5%, 3%, or 1% cutoffs.

TABLE 23
Class II MHC agretopes in CNTF

| First | Last | | | | |
|---|---|---|---|---|---|
| Residue | Residue | Sequence | 1%Hits | 3%Hits | 5%Hits |
| 16 | 24 | LCSRSIWLA | 0 | 0 | 1 |
| 21 | 29 | IWLARKIRS | 0 | 5 | 16 |
| 22 | 30 | WLARKIRSD | 1 | 2 | 3 |
| 23 | 31 | LARKIRSDL | 0 | 0 | 1 |
| 27 | 35 | IRSDLTALT | 6 | 11 | 11 |
| 38 | 46 | YVKHQGLNK | 0 | 7 | 7 |
| 44 | 52 | LNKNINLDS | 0 | 4 | 6 |
| 48 | 56 | INLDSADGM | 0 | 6 | 8 |
| 77 | 85 | LQAYRTFHV | 2 | 3 | 11 |
| 80 | 88 | YRTFHVLLA | 23 | 34 | 37 |
| 83 | 91 | FHVLLARLL | 3 | 4 | 8 |
| 85 | 93 | VLLARLLED | 0 | 2 | 3 |
| 112 | 120 | LLLQVAAFA | 0 | 1 | 5 |
| 113 | 121 | LLQVAAFAY | 0 | 2 | 2 |
| 121 | 129 | YQIEELMIL | 0 | 6 | 7 |
| 126 | 134 | LMILLEYKI | 0 | 2 | 2 |
| 130 | 138 | LEYKIPRNE | 1 | 3 | 7 |
| 132 | 140 | YKIPRNEAD | 0 | 0 | 1 |
| 156 | 164 | LWGLKVLQE | 0 | 2 | 4 |
| 157 | 165 | WGLKVLQEL | 0 | 0 | 3 |
| 159 | 167 | LKVLQELSQ | 0 | 3 | 5 |
| 165 | 173 | LSQWTVRSI | 0 | 1 | 7 |
| 168 | 176 | WTVRSIHDL | 0 | 0 | 1 |
| 170 | 178 | VRSIHDLRF | 0 | 0 | 2 |
| 176 | 184 | LRFISSHQT | 1 | 12 | 18 |
| 178 | 186 | FISSHQTGI | 0 | 2 | 2 |

Based on the above analysis, the 9-mer residues that are predicted to bind to the most MHC alleles are residues 21-29, 27-35, 77-85, 80-88, and 176-184.

The analysis was repeated for the CNTF variant Axokine®; the location of the epitopes is the same for the two proteins.

### Example 8

### Identification of Less Immunogenic CNTF Variants

In preferred embodiment, each position that contributes to MHC binding is analyzed to identify a subset of amino acid substitutions that are potentially compatible with maintaining the structure and function of the protein. This step may be performed in several ways, including PDA® calculations or visual inspection by one skilled in the art. Sequences may be generated that contain all possible combinations of amino acids that were selected for consideration at each position. Matrix method calculations can be used to determine the immunogenicity of each sequence. The results can be analyzed to identify sequences that have significantly decreased immunogenicity. Additional PDA® calculations may be performed to determine which of the minimally immunogenic sequences are compatible with maintaining the structure and function of the protein.

TABLE 28

Less immunogenic variants

| sequence | anchor1% | anchor3% | anchor5% | overlap1% | overlap3% | overlap5% |
|---|---|---|---|---|---|---|
| YRTFHVLLA | 23 | 34 | 37 | 5 | 9 | 22 |
| YEEFHQRLA | 0 | 0 | 0 | 0 | 0 | 0 |
| YKEFHQRLA | 0 | 0 | 0 | 0 | 0 | 0 |
| YQEFHQRLA | 0 | 0 | 0 | 0 | 0 | 0 |
| LEEFHARLA | 0 | 0 | 0 | 0 | 0 | 0 |
| LEEFHQRLA | 0 | 0 | 0 | 0 | 0 | 0 |
| LEELHAELA | 0 | 0 | 0 | 0 | 0 | 0 |
| LEELHAKLA | 0 | 0 | 0 | 0 | 0 | 0 |
| LEQFHARLA | 0 | 0 | 0 | 0 | 0 | 0 |
| LKEFHARLA | 0 | 0 | 0 | 0 | 0 | 0 |
| LKEFHQRLA | 0 | 0 | 0 | 0 | 0 | 0 |
| LKELHAELA | 0 | 0 | 0 | 0 | 0 | 0 |
| LKELHAKLA | 0 | 0 | 0 | 0 | 0 | 0 |
| LQEFHARLA | 0 | 0 | 0 | 0 | 0 | 0 |
| LQEFHQRLA | 0 | 0 | 0 | 0 | 0 | 0 |
| LQELHAELA | 0 | 0 | 0 | 0 | 0 | 0 |
| LQELHAKLA | 0 | 0 | 0 | 0 | 0 | 0 |
| YREFHQELA | 0 | 0 | 0 | 0 | 0 | 1 |
| YREFHQQLA | 0 | 0 | 0 | 0 | 1 | 1 |
| YRELHQELA | 0 | 0 | 0 | 0 | 0 | 1 |
| YRELHQKLA | 0 | 0 | 0 | 0 | 0 | 1 |
| YEEFHQELA | 0 | 0 | 0 | 0 | 0 | 1 |
| YEEFHQQLA | 0 | 0 | 0 | 0 | 1 | 1 |
| YEELHQELA | 0 | 0 | 0 | 0 | 0 | 1 |
| YEELHQKLA | 0 | 0 | 0 | 0 | 0 | 1 |
| YKEFHQELA | 0 | 0 | 0 | 0 | 0 | 1 |
| YKEFHQQLA | 0 | 0 | 0 | 0 | 1 | 1 |
| YKELHQELA | 0 | 0 | 0 | 0 | 0 | 1 |
| YKELHQKLA | 0 | 0 | 0 | 0 | 0 | 1 |
| YQEFHQELA | 0 | 0 | 0 | 0 | 0 | 1 |
| YQEFHQQLA | 0 | 0 | 0 | 0 | 1 | 1 |
| YQELHQELA | 0 | 0 | 0 | 0 | 0 | 1 |
| YQELHQKLA | 0 | 0 | 0 | 0 | 0 | 1 |
| LREFHAELA | 0 | 0 | 0 | 0 | 0 | 1 |
| LREFHQELA | 0 | 0 | 0 | 0 | 0 | 1 |
| LREFHQQLA | 0 | 0 | 0 | 0 | 1 | 1 |
| LEEFHAELA | 0 | 0 | 0 | 0 | 0 | 1 |
| LEEEHAQLA | 0 | 0 | 0 | 0 | 1 | 1 |
| LEEEHQELA | 0 | 0 | 0 | 0 | 0 | 1 |
| LEEFHQQLA | 0 | 0 | 0 | 0 | 1 | 1 |
| LEELHAQLA | 0 | 0 | 0 | 0 | 0 | 1 |
| LEELHARLA | 0 | 0 | 0 | 0 | 0 | 1 |
| LEQFHAELA | 0 | 0 | 0 | 0 | 0 | 1 |
| LEQFHAQLA | 0 | 0 | 0 | 0 | 1 | 1 |
| LKEFHAELA | 0 | 0 | 0 | 0 | 0 | 1 |
| LKEFHAQLA | 0 | 0 | 0 | 0 | 1 | 1 |
| LKEFHQELA | 0 | 0 | 0 | 0 | 0 | 1 |
| LKEFHQQLA | 0 | 0 | 0 | 0 | 1 | 1 |
| LKELHAQLA | 0 | 0 | 0 | 0 | 0 | 1 |
| LKELHARLA | 0 | 0 | 0 | 0 | 0 | 1 |
| LKQFHAELA | 0 | 0 | 0 | 0 | 0 | 1 |
| LQEFHAELA | 0 | 0 | 0 | 0 | 0 | 1 |
| LQEFHAQLA | 0 | 0 | 0 | 0 | 1 | 1 |
| LQEFHQELA | 0 | 0 | 0 | 0 | 0 | 1 |
| LQEFHQQLA | 0 | 0 | 0 | 0 | 1 | 1 |
| LQELHAQLA | 0 | 0 | 0 | 0 | 0 | 1 |
| LQELHARLA | 0 | 0 | 0 | 0 | 0 | 1 |
| LQQFHAELA | 0 | 0 | 0 | 0 | 0 | 1 |
| YREFHQKLA | 0 | 0 | 0 | 0 | 0 | 2 |
| YRELHQQLA | 0 | 0 | 0 | 0 | 0 | 2 |
| YEEFHARLA | 0 | 0 | 0 | 0 | 0 | 2 |
| YEEFHQKLA | 0 | 0 | 0 | 0 | 0 | 2 |
| YEELHQQLA | 0 | 0 | 0 | 0 | 0 | 2 |
| YEELHQRLA | 0 | 0 | 0 | 0 | 0 | 2 |
| YKEFHQKLA | 0 | 0 | 0 | 0 | 0 | 2 |
| YKELHQQLA | 0 | 0 | 0 | 0 | 0 | 2 |
| YKELHQRLA | 0 | 0 | 0 | 0 | 0 | 2 |
| YQEFHQKLA | 0 | 0 | 0 | 0 | 0 | 2 |
| YQELHQQLA | 0 | 0 | 0 | 0 | 0 | 2 |
| YQELHQRLA | 0 | 0 | 0 | 0 | 0 | 2 |
| LREFHVELA | 0 | 0 | 0 | 0 | 1 | 2 |
| LREFHAKLA | 0 | 0 | 0 | 0 | 0 | 2 |
| LREFHQKLA | 0 | 0 | 0 | 0 | 0 | 2 |
| LRELHVELA | 0 | 0 | 0 | 0 | 0 | 2 |
| LEAFHARLA | 0 | 0 | 0 | 0 | 2 | 2 |
| LEEFHVELA | 0 | 0 | 0 | 0 | 1 | 2 |
| LEEFHAKLA | 0 | 0 | 0 | 0 | 0 | 2 |
| LEEFHQKLA | 0 | 0 | 0 | 0 | 0 | 2 |
| LEELHVELA | 0 | 0 | 0 | 0 | 0 | 2 |
| LEQFHVELA | 0 | 0 | 0 | 0 | 1 | 2 |
| LEQFHAKLA | 0 | 0 | 0 | 0 | 0 | 2 |
| LKEFHVELA | 0 | 0 | 0 | 0 | 1 | 2 |
| LKEFHAKLA | 0 | 0 | 0 | 0 | 0 | 2 |
| LKEFHQKLA | 0 | 0 | 0 | 0 | 0 | 2 |
| LKELHVELA | 0 | 0 | 0 | 0 | 0 | 2 |
| LKQFHAKLA | 0 | 0 | 0 | 0 | 0 | 2 |
| LQEFHVELA | 0 | 0 | 0 | 0 | 1 | 2 |
| LQEFHAKLA | 0 | 0 | 0 | 0 | 0 | 2 |
| LQEFHQKLA | 0 | 0 | 0 | 0 | 0 | 2 |
| LQELHVELA | 0 | 0 | 0 | 0 | 0 | 2 |
| LQQFHAKLA | 0 | 0 | 0 | 0 | 0 | 2 |
| YREFHAELA | 0 | 0 | 0 | 0 | 0 | 3 |
| YEEFHAELA | 0 | 0 | 0 | 0 | 0 | 3 |
| YEEFHAQLA | 0 | 0 | 0 | 0 | 1 | 3 |
| YEELHAELA | 0 | 0 | 0 | 0 | 2 | 3 |
| YEELHAKLA | 0 | 0 | 0 | 0 | 2 | 3 |
| YKEFHAELA | 0 | 0 | 0 | 0 | 0 | 3 |
| YKEFHAQLA | 0 | 0 | 0 | 0 | 1 | 3 |
| YKELHAELA | 0 | 0 | 0 | 0 | 2 | 3 |
| YKELHAKLA | 0 | 0 | 0 | 0 | 2 | 3 |
| YQEFHAELA | 0 | 0 | 0 | 0 | 0 | 3 |
| YQEFHAQLA | 0 | 0 | 0 | 0 | 1 | 3 |
| YQELHAELA | 0 | 0 | 0 | 0 | 2 | 3 |
| YQELHAKLA | 0 | 0 | 0 | 0 | 2 | 3 |
| LRELHLELA | 0 | 0 | 0 | 0 | 1 | 3 |
| LRELHQELA | 0 | 0 | 0 | 0 | 0 | 3 |
| LRELHQKLA | 0 | 0 | 0 | 0 | 0 | 3 |
| LEAFHAELA | 0 | 0 | 0 | 0 | 2 | 3 |
| LEAFHAQLA | 0 | 0 | 0 | 0 | 3 | 3 |
| LEELHLELA | 0 | 0 | 0 | 0 | 1 | 3 |
| LEELHQELA | 0 | 0 | 0 | 0 | 0 | 3 |
| LEELHQKLA | 0 | 0 | 0 | 0 | 0 | 3 |
| LKAFHAELA | 0 | 0 | 0 | 0 | 2 | 3 |
| LKELHLELA | 0 | 0 | 0 | 0 | 1 | 3 |
| LKELHQELA | 0 | 0 | 0 | 0 | 0 | 3 |
| LKELHQKLA | 0 | 0 | 0 | 0 | 0 | 3 |
| LQAFHAELA | 0 | 0 | 0 | 0 | 2 | 3 |
| LQELHLELA | 0 | 0 | 0 | 0 | 1 | 3 |
| LQELHQELA | 0 | 0 | 0 | 0 | 0 | 3 |
| LQELHQKLA | 0 | 0 | 0 | 0 | 0 | 3 |
| LRELHAELA | 0 | 0 | 1 | 0 | 0 | 0 |
| LRELHAKLA | 0 | 0 | 1 | 0 | 0 | 0 |
| LREFHAQLA | 0 | 0 | 1 | 0 | 1 | 1 |
| LKQFHAQLA | 0 | 0 | 2 | 0 | 1 | 1 |
| LQQFHAQLA | 0 | 0 | 2 | 0 | 1 | 1 |
| YKEFHARLA | 0 | 0 | 2 | 0 | 0 | 2 |
| YQEFHARLA | 0 | 0 | 2 | 0 | 0 | 2 |
| LKQFHVELA | 0 | 0 | 2 | 0 | 1 | 2 |
| LQQFHVELA | 0 | 0 | 2 | 0 | 1 | 2 |
| YEQFHARLA | 0 | 0 | 2 | 0 | 2 | 3 |
| LKAFHAQLA | 0 | 0 | 2 | 0 | 3 | 3 |
| LQAFHAQLA | 0 | 0 | 2 | 0 | 3 | 3 |
| LREFHQRLA | 0 | 0 | 3 | 0 | 0 | 0 |
| YRELHAELA | 0 | 1 | 1 | 0 | 2 | 3 |
| LRELHAQLA | 0 | 1 | 2 | 0 | 0 | 1 |
| YREFHAQLA | 0 | 1 | 2 | 0 | 1 | 3 |
| YRELHAKLA | 0 | 1 | 2 | 0 | 2 | 3 |
| YRELHQRLA | 0 | 2 | 3 | 0 | 0 | 2 |

Using the above preferred embodiment, sequences were identified for the residue 80-88 epitope. These sequences eliminate all or most of the hits in the 80-88 epitope and also eliminate all or nearly all of the hits in the overlapping epitopes. The wild-type sequence and scores are shown in the top row of data for reference. In all of the variants shown below, it is possible to replace Y80 with alternate non-hydrophobic residues, including D, E, G, H, K, N, Q, R, S, and T.

### Example 9

### Identification of Structured, Less Immunogenic CNTF Variants

PDA® calculations were performed to predict the energies of each of the less immunogenic variants of the major epitopes in CNTF, as well as the native sequence. The energies of the native sequences were then compared with the energies of the variants to determine which of the less immunogenic CNTF sequences are compatible with maintaining the structure and function of CNTF. Unless otherwise noted, the nine residues comprising an epitope of interest were determined to be the variable residue positions. Coordinates for the CNTF template were obtained from PDB ascession code 1CNT. A variety of rotameric states were considered for each variable position, and the sequence was constrained to be the sequence of a specific less immunogenic variant identified previously. Rotamer-template and rotamer-rotamer energies were then calculated using a force field including terms describing van der Waals interactions, hydrogen bonds, electrostatics, and solvation. The optimal rotameric configurations for each sequence were determined using DEE as a combinatorial optimization method.

In general, all of the sequences whose energies are similar to or better than (that is, less than) the energy of the native sequence are likely to be structured. Sequences that conserve those residues that are known to be important for function are likely to also be active. Alternatively, it is possible to experimentally determine or model the interaction of CNTF with its receptors and then to determine which variant sequences are compatible with forming this interaction.

Less immunogenic CNTF variants that are predicted to be compatible with maintaining the structure and function of CNTF include, but are not limited to, the following:

TABLE 29

Identification of stable,
less immunogenic CNTF variants

| sequence | energy | anchor1% | anchor3% | anchor5% | overlap1% | overlap3% | overlap5% |
|---|---|---|---|---|---|---|---|
| YRTFHVLLA | −63.60 | 23 | 34 | 37 | 5 | 9 | 22 |
| YEEFHARLA | −77.63 | 0 | 0 | 0 | 0 | 0 | 2 |
| YEQFHARLA | −75.51 | 0 | 0 | 2 | 0 | 2 | 3 |
| YEEFHAQLA | −75.43 | 0 | 0 | 0 | 0 | 1 | 3 |
| YEEFHAELA | −74.19 | 0 | 0 | 0 | 0 | 0 | 3 |
| YEELHAKLA | −73.61 | 0 | 0 | 0 | 0 | 2 | 3 |
| YQEFHARLA | −73.33 | 0 | 0 | 2 | 0 | 0 | 2 |
| YEELHAELA | −72.93 | 0 | 0 | 0 | 0 | 2 | 3 |
| YKEFHARLA | −72.81 | 0 | 0 | 2 | 0 | 0 | 2 |
| YREFHAQLA | −72.22 | 0 | 1 | 2 | 0 | 1 | 3 |
| YQEFHAQLA | −71.18 | 0 | 0 | 0 | 0 | 1 | 3 |
| YREFHAELA | −71.02 | 0 | 0 | 0 | 0 | 0 | 3 |
| YKEFHAQLA | −70.79 | 0 | 0 | 0 | 0 | 1 | 3 |
| YQEFHAELA | −69.99 | 0 | 0 | 0 | 0 | 0 | 3 |
| YRELHAKLA | −69.94 | 0 | 1 | 2 | 0 | 2 | 3 |
| YRELHAELA | −69.77 | 0 | 1 | 1 | 0 | 2 | 3 |
| YKEFHAELA | −69.60 | 0 | 0 | 0 | 0 | 0 | 3 |
| YQELHAKLA | −69.31 | 0 | 0 | 0 | 0 | 2 | 3 |
| YQELHAELA | −68.73 | 0 | 0 | 0 | 0 | 2 | 3 |
| YKELHAKLA | −68.47 | 0 | 0 | 0 | 0 | 2 | 3 |
| YKELHAELA | −68.35 | 0 | 0 | 0 | 0 | 2 | 3 |
| YEELHQRLA | −68.15 | 0 | 0 | 0 | 0 | 0 | 2 |
| YEEFHQQLA | −66.52 | 0 | 0 | 0 | 0 | 1 | 1 |
| LEELHARLA | −65.86 | 0 | 0 | 0 | 0 | 0 | 1 |
| YEEFHQELA | −65.49 | 0 | 0 | 0 | 0 | 0 | 1 |
| YEELHQQLA | −65.37 | 0 | 0 | 0 | 0 | 0 | 2 |
| LEQFHAQLA | −65.33 | 0 | 0 | 0 | 0 | 1 | 1 |
| LEEFHAQLA | −64.87 | 0 | 0 | 0 | 0 | 1 | 1 |
| LEQFHAELA | −64.85 | 0 | 0 | 0 | 0 | 0 | 1 |
| LEQFHAKLA | −64.45 | 0 | 0 | 0 | 0 | 0 | 2 |
| YEELHQELA | −64.23 | 0 | 0 | 0 | 0 | 0 | 1 |
| LEEFHAKLA | −64.04 | 0 | 0 | 0 | 0 | 0 | 2 |
| YQELHQRLA | −63.85 | 0 | 0 | 0 | 0 | 0 | 2 |
| YEEFHQKLA | −63.82 | 0 | 0 | 0 | 0 | 0 | 2 |
| LEEFHAELA | −63.63 | 0 | 0 | 0 | 0 | 0 | 1 |

What is claimed is:

1. A method for generating, from a parent protein, a variant protein having desired immunological and functional properties, said method comprising:
a) inputting the coordinates of a structure of a parent protein into a computer;
b) identifying the amino acid positions of at least a first immunogenic sequence in said parent protein;
c) generating one or more variant sequences comprising at least one amino acid substitution of at least one position of said first immunogenic sequence in said parent protein;
d) applying, in any order:
i) at least one computational protein design algorithm that analyzes the compatibility of said variant sequence with the structure or function of said parent protein; and
ii) at least one computational immunogenicity filter that analyzes the immunological properties of said variant sequence; and
e) identifying at least one variant protein having desired immunological and functional properties.

2. A method according to claim 1, wherein said desired immunological property is enhanced uptake by antigen presenting cells (APCs).

3. A method according to claim 1, wherein said desired immunological property is reduced immunogenicity.

4. A method according to claim 1, wherein said desired immunological property is enhanced immunogenicity.

5. A method according to claim 1, wherein said immunogenic sequence is selected from the group consisting of: an antigen processing cleavage site, a class I MHC agretope, a class II MHC agretope, and an antibody epitope.

6. A method according to claim 1, wherein said immunogenicity filter comprises a function that predicts antigen processing cleavage sites.

7. A method according to claim 1, wherein said immunogenicity filter comprises a function that predicts class I MHC agretopes.

8. A method according to claim 1, wherein said immunogenicity filter comprises a function that predicts class II MHC agretopes.

9. A method according to claim 1, wherein said immunogenicity filter comprises a matrix method calculation.

10. A method according to claim 1, wherein said immunogenicity filter comprises a function that predicts antibody epitopes.

11. A method according to claim 1, wherein said computational protein design algorithm comprises a scoring function with two or more terms selected from the list: van der Waals, hydrogen bonding, electrostatics, solvation, and secondary structure propensity.

12. A method according to claim 1, wherein said computational protein design algorithm is used to assess the stability of said variant protein.

13. A method according to claim 1, wherein said computational protein design algorithm is used to assess the affinity of said variant protein for one or more receptor or ligand molecules.

14. A method according to claim 1, wherein said computational protein design algorithm is PDA® technology.

15. A method according to claim 1, further comprising experimentally generating said variant protein.

16. A method according to claim 15, further comprising recovering said variant protein.

17. A method according to claim 15, further comprising administering said variant protein to a patient.

18. A variant protein with reduced immunogenicity made using the method of claim 1.

19. A variant protein with enhanced immunogenicity made using the method of claim 1.

20. A nucleic acid encoding the variant protein of claim 18.

21. A nucleic acid encoding the variant protein of claim 19.
